(19) United States
(12) Patent Application Publication
(10) Pub. No.: US 2026/0227640 A1
(43) Pub. Date: Aug. 6, 2026

(54) FILM, OPTICAL MEMBER, OPTICAL DEVICE, AND HEAD-MOUNTED DISPLAY

(71) Applicant: FUJIFILM Corporation, Tokyo (JP)

(72) Inventors: Fumitake MITOBE, Minamiashigara-shi (JP); Naoki KOITO, Minamiashigara-shi (JP)

(73) Assignee: FUJIFILM Corporation, Tokyo (JP)

(21) Appl. No.: 19/575,972

(22) Filed: Mar. 24, 2026

Related U.S. Application Data
(63) Continuation of application No. PCT/JP2024/033911, filed on Sep. 24, 2024.

(30) Foreign Application Priority Data
Oct. 6, 2023 (JP) 2023-174286

(51) Int. Cl. G02B 27/28; G02B 5/30; G02B 27/01

(52) U.S. Cl. CPC G02B 27/288; G02B 5/3083; G02B 27/0172; G02B 2027/012; G02B 2027/0178

(57) ABSTRACT

An object of the present invention is to provide a film in which generation of multiple images is suppressed in a case of being applied to AR glasses. The film according to the embodiment of the present invention is a film including at least one or more light-absorbing anisotropic layers, in which an angle between a transmittance central axis of the light-absorbing anisotropic layer and a normal direction of the light-absorbing anisotropic layer is 0° to 45°, and a maximum height difference of undulation in a region of 10 mm× 10 mm on a film surface is 1.2 μm or less.

### CROSS-REFERENCE TO RELATED APPLICATIONS

This application is a Continuation of PCT International Application No. PCT/JP2024/033911 filed on Sep. 24, 2024, which claims priority under 35 U.S.C. § 119(a) to Japanese Patent Application No. 2023-174286 filed on Oct. 6, 2023. The above applications are hereby expressly incorporated by reference, in their entirety, into the present application.

### BACKGROUND OF THE INVENTION

### 1. Field of the Invention

The present invention relates to a film and an optical member including the film.

In addition, the present invention relates to an optical device including the optical member and a head-mounted display including the optical device.

### 2. Description of the Related Art

In recent years, a head-mounted display such as augmented reality (AR) glasses that projects a video to be superimposed on a background has been put into practical use.

The AR glasses are configured to include, for example, an image display element, a light guide plate, and a diffraction element, in which video light emitted from the image display element is diffracted by the diffraction element, is incident into the light guide plate, and is guided by the light guide plate such that the guided video light is diffracted by the diffraction element to display the video toward a viewer.

The light guide plate is often transparent, and the AR glasses can project a video to be superimposed on a background.

In the AR glasses, external light incident from a specific oblique direction is diffracted in the direction of the viewer by the diffraction element. Therefore, there is a problem in that rainbow unevenness in which external light is recognized by the viewer in an iridescently reflected glare state on the background is recognized. The specific oblique direction refers to a direction perpendicular (substantially perpendicular) to a slit direction of the diffraction element.

An incidence angle (incidence angle oblique to a main surface of the diffraction element) at which external light is recognized changes depending on a pitch of the diffraction element. However, there is particularly a problem in that external light incident at 40° to 80° with respect to the normal line of the diffraction element is recognized as the rainbow unevenness.

For example, in the diffraction element where the slit direction is close to the horizontal direction in the usage state of the AR glasses or the like, external light incident from the upper front side of the head is recognized as reflected glare rainbow unevenness.

Examples of a method of suppressing the rainbow unevenness include a method of disposing a film that suppresses incidence of external light at the above-described angle with respect to the normal line of the diffraction element. Examples of the film having such a function include a film in which an absorption axis of a polarizer is a direction perpendicular to a film surface of the polarizer, as described in JP2008-165201A. In the film as described above, light in a direction tilted from the direction perpendicular to the film surface of the polarizer is less likely to be transmitted.

### SUMMARY OF THE INVENTION

The present inventors have found that, in a case where a film produced with reference to the film described in JP2008-165201A is applied to suppress rainbow unevenness of AR glasses, an image may be seen in multiple images (multiple images may be generated).

In particular, in a case where a light guide plate of the AR glasses and a cover member of the AR glasses are disposed to be spaced from each other and the film is disposed on a light guide plate side of the cover member, the generation of multiple images is more remarkably observed.

Therefore, an object of the present invention is to provide a film in which the generation of multiple images is suppressed in a case of being applied to AR glasses.

Another object of the present invention is to provide an optical member including a film, an optical device, and a head-mounted display.

The present inventors conducted a thorough investigation to achieve the object, thereby completing the present invention. That is, the present inventors have found that the foregoing objects can be achieved by the following configurations.

[1] A film comprising: at least one light-absorbing anisotropic layer, in which an angle between a transmittance central axis of the light-absorbing anisotropic layer and a normal direction of the light-absorbing anisotropic layer is 0° to 45°, and a maximum height difference of undulation in a region of 10 mm×10 mm on a film surface is 1.2 μm or less.

[2] The film according to [1], further comprising: two light-absorbing anisotropic layers, in which at least one or more retardation layers are provided between the two light-absorbing anisotropic layers.

[3] The film according to [2], in which two retardation layers are provided, and the retardation layer is a λ/2 plate.

[4] The film according to any one of [1] to [3], further comprising: a polarizer.

[5] The film according to any one of [1] to [4], further comprising: an antireflection layer disposed on an outermost side of the film.

[6] The film according to any one of [1] to [5], in which a surface reflectivity is 1% or less.

[7] The film according to any one of [1] to [6], further comprising: one or more layers selected from the group consisting of a pressure sensitive adhesive layer having a film thickness of 10 μm or less and an adhesive layer having a film thickness of 10 μm or less.

[8] An optical member comprising: the film according to any one of [1] to [7]; and a transparent support.

[9] The optical member according to [8], in which the transparent support is a glass.

[10] An optical device comprising: the optical member according to [8]; and a light guide plate in which a diffraction element is disposed on a surface, in which the optical member and the light guide plate are disposed to be spaced from each other.

[11] The optical device according to [10], in which the transparent support in the optical member is disposed on a light guide plate side with respect to the film.

[12] A head-mounted display comprising: the optical device according to [10]; and an image display element.

[13] The head-mounted display according to [11], comprising: the optical device according to [10]; and an image display element.

According to the present invention, it is possible to provide a film in which the generation of multiple images is suppressed in a case of being applied to AR glasses.

In addition, according to the present invention, it is also possible to provide an optical member including a film, an optical device, and a head-mounted display.

### BRIEF DESCRIPTION OF THE DRAWINGS

FIG. 1 is a schematic view showing an example of a first embodiment of a film according to the present invention.

FIG. 2 is a schematic view showing an example of a second embodiment of the film according to the present invention.

FIG. 3 is a schematic cross-sectional view showing a part of AR glasses according to the present invention.

FIG. 4 is a schematic cross-sectional view showing a part of AR glasses in a case where a related-art film for preventing rainbow unevenness is applied to the AR glasses

### DESCRIPTION OF THE PREFERRED EMBODIMENTS

Hereinafter, the present invention will be described in detail.

The description of the configuration requirements described below may be made based on the representative embodiments of the present invention, but the present invention is not limited to those embodiments.

Hereinafter, meaning of each description in the present specification will be explained.

In the present specification, numerical ranges represented by “to” include numerical values before and after “to” as lower limits and upper limits.

In addition, in the present specification, the terms parallel and orthogonal do not respectively indicate parallel and orthogonal in a strict sense, but respectively indicate a range of parallel±5° and a range of orthogonal±5°.

In addition, in the present specification, materials that correspond to each component may be used alone or in combination of two or more kinds. Here, in a case where two or more kinds of materials are used in combination for each component, the content of the component refers to the total content of the materials to be combined unless specified otherwise.

In addition, in the present specification, “(meth)acrylate” denotes “acrylate” or “methacrylate”, “(meth)acryl” denotes “acryl” or “methacryl”, and “(meth)acryloyl” denotes “acryloyl” or “methacryloyl”.

In the present specification, Re(λ) and Rth(λ) represent an in-plane retardation and a thickness-direction retardation at a wavelength λ, respectively. Unless otherwise specified, it is assumed that the wavelength λ is 550 nm.

In the present invention, Re(λ) and Rth(λ) are values measured at the wavelength λ in AxoScan OPMF-2 (manufactured by Opto Science, Inc.). By inputting an average refractive index ((nx+ny+nz)/3) and a film thickness (d (μm)) in AxoScan,
a slow axis direction (°),

$$Re ( λ ) = R 0 ( λ ) , and$$

$$Rth ( λ ) = ( ( nx + ny ) / 2 - nz ) \times d$$

are calculated.

Although R0 (λ) is displayed as a numerical value calculated by AxoScan OPMF-2, it means Re (λ).

In the present specification, the transmittance central axis means a direction in which the highest transmittance is exhibited in a case where the transmittance is measured by changing an inclination angle (polar angle) and an inclination direction (azimuthal angle) with respect to a normal direction of a surface of the light-absorbing anisotropic layer.

Specifically, the Mueller matrix at a wavelength of 550 nm is measured using AxoScan OPMF-2 (manufactured by Opto Science, Inc.). More specifically, in the measurement, an azimuthal angle at which the transmittance central axis is inclined is first searched for, the Mueller matrix at a wavelength of 550 nm is measured while the polar angle which is the angle with respect to the normal direction of the surface of the light-absorbing anisotropic layer is changed from −70° to 70° at intervals of 1° in the surface (the plane that has the transmittance central axis and is orthogonal to the layer surface) having the normal direction of the light-absorbing anisotropic layer along the azimuthal angle, and the transmittance of the light-absorbing anisotropic layer is derived. As a result, the direction at which the highest transmittance is exhibited is defined as the transmittance central axis.

The transmittance central axis denotes a direction of an absorption axis (major axis direction of a molecule) of the dichroic substance contained in the light-absorbing anisotropic layer.

In addition, in the present specification, the refractive indices nx, ny, and nz are measured using an Abbe refractometer (NAR-4T, manufactured by Atago Co., Ltd.), and a sodium lamp (λ=589 nm) is used as a light source. In addition, the wavelength dependence can be measured using a combination of a multi-wavelength Abbe refractometer DR-M2 (manufactured by Atago Co., Ltd.) and an interference filter.

In addition, the values in Polymer Handbook (John Wiley & Sons, Inc.) and catalogs of various optical films can be used. The values of average refractive index of major optical films are as follows: cellulose acylate (1.48), cycloolefin polymer (1.52), polycarbonate (1.59), polymethyl methacrylate (1.49), and polystyrene (1.59).

In addition, the bonding direction of a divalent group (for example, —COO—) described in the present specification is not particularly limited. For example, in a case where L in X-L-Y is —COO— and in a case where the position bonded to the X side is defined as *1 and the position bonded to the Y side is defined as *2, L may be *1-O—CO—*2 or *1-CO—O—*2.

### <Film>

The film according to the embodiment of the present invention is a film including at least one light-absorbing anisotropic layer, wherein an angle between a transmittance central axis of the light-absorbing anisotropic layer and a normal direction of the light-absorbing anisotropic layer is 0° to 45°, and a maximum height difference of undulation in a region of 10 mm×10 mm on a film surface is 1.2 μm or less. A method of measuring the maximum height difference of undulation will be described in detail later.

In a case where the film according to the embodiment of the present invention is applied to AR glasses, a mechanism for suppressing generation of multiple images is not always clear, but the present inventors have presumed as follows.

First, a principle in a case where a film for preventing rainbow unevenness is applied to AR glasses in the related art, in which multiple images are considered to occur, will be described with reference to a drawing.

FIG. 4 is a schematic cross-sectional view showing a part of AR glasses in a case where a film for preventing rainbow unevenness in the related art is applied to the AR glasses (head-mounted display).

Specifically, AR glasses 40C shown in FIG. 4 include an optical device 30C and an image display element 42 that causes video light L1 to be incident on the optical device.

The optical device 30C includes a light guide plate 32, and an incidence diffraction element 34 and an emission diffraction element 36 that are disposed on a side of the light guide plate 32 opposite to the image display element 42. In addition, the optical device 30 includes an optical member 20C consisting of a cover glass 22 and a film 10C (film for preventing rainbow unevenness in the related art). In the optical member 20C, the film 10C is disposed on the light guide plate 32 side. The film 10C, the incidence diffraction element 34, and the emission diffraction element 36 are disposed to be spaced from each other.

A disposition position of the incidence diffraction element 34 corresponds to an incidence position of the video light L1 from the image display element 42. The disposition position of the emission diffraction element 36 corresponds to an emission position of the video light L1 from the light guide plate 32, that is, an observation position of the video light L1 by the user.

The incidence diffraction element 34 diffracts the video light L1 incident on the light guide plate 32 from the image display element 42 into the light guide plate 32. The diffracted video light L1 travels in an in-plane direction of the light guide plate 32 while being totally reflected in the light guide plate 32. The emission diffraction element 36 diffracts the light transmitted in the light guide plate 32 to a user side.

In the emission diffraction element 36 of the AR glasses 40C, it was clarified by the studies of the inventors that a part of the video light L1 is emitted to a side opposite to the user side (optical member 20C side) to generate stray light Ls. The stray light Ls travels to the optical member 20C side and a part of the stray light Ls is reflected by a surface of the film 10C.

Here, in the film 10C, the surface thereof is likely to have undulation, and the stray light Ls is reflected in a direction not parallel to the video light L1 and is observed by the user. In a case where the stray light Ls is reflected in a direction different from the video light L1, an image generated by the stray light Ls is observed at a position different from an image generated by the video light L1. Therefore, it is considered that multiple images are generated.

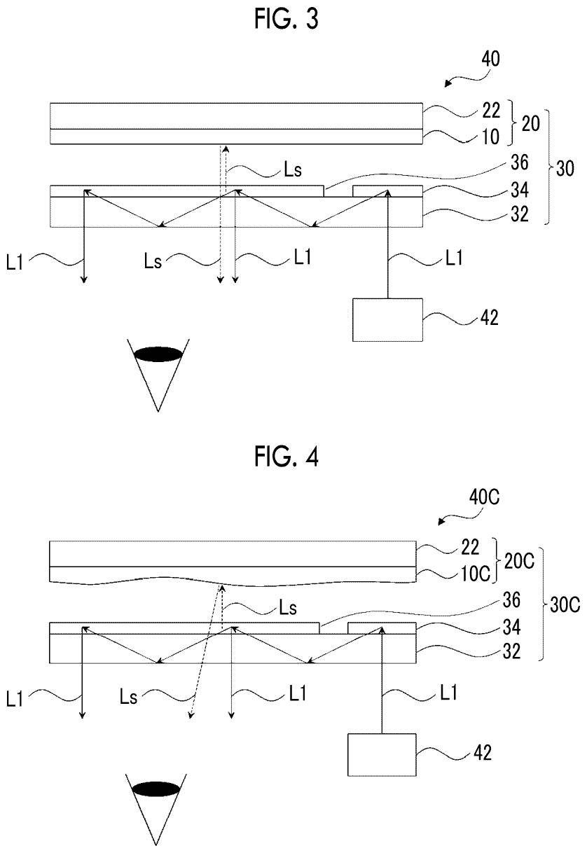

On the other hand, in the film according to the embodiment of the present invention, the maximum height difference of the undulation in a region of 10 mm×10 mm on the film surface is 1.2 μm or less. Therefore, even in a case where the stray light Ls is generated, the stray light Ls is likely to be reflected in the same direction as the video light L1, and as a result, it is considered that the generation of multiple images is suppressed (see FIG. 3 described later).

Hereinafter, as a representative aspect of the film according to the embodiment of the present invention, a first embodiment and a second embodiment will be described in detail. The film according to the embodiment of the present invention is not limited to the following aspects, and the components thereof can be appropriately changed.

### First Embodiment

In the first embodiment of the film according to the embodiment of the present invention, two light-absorbing anisotropic layers are provided, and at least one or more retardation layers are provided between the two light-absorbing anisotropic layers. In the two light-absorbing anisotropic layers, an angle between a transmittance central axis of the light-absorbing anisotropic layer and a normal direction of the light-absorbing anisotropic layer is 0° to 45°. The maximum height difference of the undulation in a region of 10 mm×10 mm on the film surface is 1.2 μm or less.

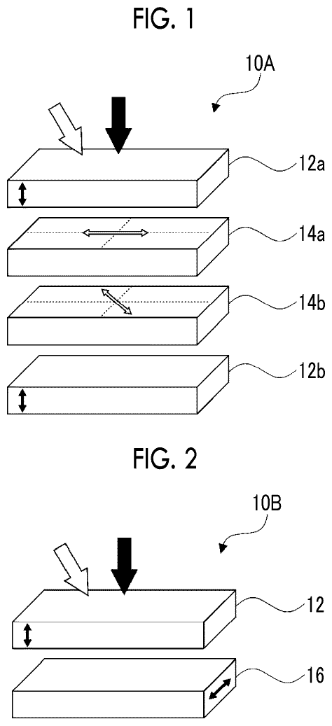

FIG. 1 is a schematic view showing an example of the first embodiment of the film according to the embodiment of the present invention.

A film 10A shown in FIG. 1 includes a first light-absorbing anisotropic layer 12a, a first retardation layer 14a, a second retardation layer 14b, and a second light-absorbing anisotropic layer 12b in this order. In the first light-absorbing anisotropic layer 12a and the second light-absorbing anisotropic layer 12b shown in FIG. 1, an angle between a transmittance central axis and a normal direction of the light-absorbing anisotropic layer (the first light-absorbing anisotropic layer 12a and the second light-absorbing anisotropic layer 12b) is 0° (corresponding to black double-headed arrows in the first light-absorbing anisotropic layer 12a and the second light-absorbing anisotropic layer 12b in FIG. 1). In addition, in the aspect shown in FIG. 1, the first retardation layer 14a and the second retardation layer 14b are λ/2 plates, and the in-plane slow axis directions of the first retardation layer 14a and the second retardation layer 14b are disposed such that an angle formed therebetween is 45° as observed from the normal direction (corresponding to white double-headed arrows in the first retardation layer 14a and the second retardation layer 14b in FIG. 1).

In the film of the first embodiment having the configuration shown in FIG. 1, light incident from the transmittance central axis direction (direction of black arrow in FIG. 1) of the first light-absorbing anisotropic layer 12a and the second light-absorbing anisotropic layer 12b is transmitted without undergoing polarization conversion. On the other hand, in light incident from a direction tilted from the transmittance central axis (direction of white arrow in FIG. 1), a component of a vibration direction in an in-plane direction of a plane including the direction and the transmittance central axis (hereinafter, also referred to as “P-polarized light” in this paragraph) is partially absorbed by the first light-absorbing anisotropic layer 12a, and a component of a vibration direction in a direction orthogonal to the P-polarized light (hereinafter, also referred to as “S-polarized light”) is transmitted while being hardly absorbed by the first light-absorbing anisotropic layer 12a. In this case, the light incident from the direction tilted from the transmittance central axis is light having a large S-polarized light component in a case of being transmitted through the first light-absorbing anisotropic layer 12a.

In FIG. 1, the plane including the direction tilted from the transmittance central axis and the transmittance central axis is parallel to the in-plane slow axis direction of the first retardation layer 14a.

In the aspect shown in FIG. 1, the S-polarized light component in the light transmitted through the first light-absorbing anisotropic layer 12a is hardly subjected to polarization conversion in the first retardation layer 14a, but is subjected to polarization conversion in the second retardation layer 14b, and the vibration direction is rotated by approximately 90° to be the P-polarized light component. In a case where the light is converted into the P-polarized light component, the light is absorbed by the second light-absorbing anisotropic layer 12b.

It can be said that the absorption of light as described above is the same for light incident from any azimuthal angle as long as the light is incident from the direction tilted from the transmittance central axis. For example, in a case of light incident from a direction rotated by 45° from the azimuthal angle in the direction of the white arrow, the S-polarized light component transmitted is subjected to polarization conversion in the first retardation layer 14a to be the P-polarized light component, and the P-polarized light component is hardly subjected to polarization conversion in the second retardation layer 14b and is absorbed by the second light-absorbing anisotropic layer 12b.

As described above, in the aspect shown in FIG. 1, as long as the light is incident from the direction tilted from the transmittance central axis, the light is absorbed by the first light-absorbing anisotropic layer 12a or the second light-absorbing anisotropic layer 12b regardless of the azimuthal angle from which the light is incident. On the other hand, light incident from the transmittance central axis direction is transmitted without being absorbed. Therefore, in a case of being applied to AR glasses, the aspect shown in FIG. 1 functions as a filter in which the transmittance of light incident from the transmittance central axis direction (for example, the visual perception direction) is high and the transmittance of light incident from an oblique direction is low. Such a filter can prevent external light from being incident into a diffraction element provided in AR glasses from an oblique direction, and thus can suppress rainbow unevenness in a case of being applied to AR glasses.

In the above description, the aspect in which two retardation layers are disposed between two light-absorbing anisotropic layers has been described, but one retardation layer may be disposed between the light-absorbing anisotropic layers. Even in a case where one retardation layer is disposed between the light-absorbing anisotropic layers, the retardation layer functions as a filter that absorbs light incident from an oblique direction and has a low transmittance of light incident from an oblique direction, according to the above-described principle.

Hereinafter, the first embodiment of the film according to the present invention will be described in detail.

### (Maximum Height Difference of Undulation)

As described above, in the first embodiment of the film according to the present invention, the maximum height difference of undulation in a region of 10 mm×10 mm is 1.2 μm or less.

In the present specification, the maximum height difference of undulation of the film is measured as follows.

In the present specification, the maximum height difference of undulation is measured using a three-dimensional optical profiler (New View 7200, manufactured by Zygo Corporation). In addition, as measurement and analysis software, Advanced Texture Application of MetroPro ver 9.0.10 is used. In addition, the analysis conditions are set to High FFT Filter: Auto, Low FFT Filter: Auto, and Noise Filter Size: 0. In the above-described analysis, in a case where the AUTO function is not used, the analysis is performed under conditions of High Filter Wavelength of 330 μm and Low Filter Wavelength of 1020 μm.

In a case where the high-frequency components are removed from the three-dimensional profile obtained by the above-described analysis, the degree of undulation in the three-dimensional profile can be evaluated. Hereinafter, the curved surface obtained by removing the high-frequency components from the three-dimensional profile is also referred to as an “undulation curved surface”.

First, the surface of glass (manufactured by Corning Incorporated, EAGLE XG) is measured in a region of 10 mm×10 mm using the above-described three-dimensional optical profiler, and 10 three-dimensional profiles are acquired while changing the measurement position. The undulation curved surface is acquired from the 10 three-dimensional profiles under the above-described analysis software and conditions. The maximum height difference of the undulation curved surface (maximum height difference of undulation) at each of the obtained measurement positions is calculated, and an arithmetic average value of the maximum height differences of undulation at 10 positions is obtained. The average value of the maximum height differences of undulation of the glass is denoted by Wg (unit: μm).

Subsequently, the film is bonded to the glass through opteria (registered trademark) NCF-D692 (film thickness: 15 μm, manufactured by LINTEC Corporation). For the surface of the film bonded to the glass on the film side opposite to the glass side, 10 three-dimensional profiles are acquired in the same manner as described above, and an undulation curved surface is obtained for each of the 10 three-dimensional profiles. Next, the maximum height difference of the undulation curved surface at the 10 obtained positions is calculated, and an arithmetic average value of the maximum height differences of undulation is obtained. The average value of the maximum height differences of undulation of the glass is denoted by Wf (unit: μm).

Here, the “maximum height difference of undulation” of the film in the present invention refers to a value (unit: μm) obtained by subtracting Wg from Wf.

From the viewpoint of further suppressing the generation of multiple images in a case of being applied to AR glasses, the maximum height difference of undulation is preferably 1.0 μm or less, more preferably 0.8 μm or less, and still more preferably 0.6 μm or less. The lower limit of the maximum height difference of undulation is not particularly limited, but is 0.1 μm or more in many cases.

### (Optical Absorption Anisotropic Layer)

The first embodiment of the film according to the present invention includes two light-absorbing anisotropic layers. Hereinafter, in a case where the two light-absorbing anisotropic layers do not need to be distinguished, the two light-absorbing anisotropic layers may be collectively referred to as “light-absorbing anisotropic layer”.

In the light-absorbing anisotropic layer, an angle between a transmittance central axis of the light-absorbing anisotropic layer and a normal direction of the light-absorbing anisotropic layer is 0° to 45°, preferably 0° or more and less than 45°, more preferably 0° or more and 35° or less, and still more preferably 0° or more and less than 35°. From the viewpoint of further improving the light transmittance, it is preferable that the transmittance central axes of the two light-absorbing anisotropic layers are parallel to each other.

The light-absorbing anisotropic layer preferably contains a dichroic substance, more preferably contains a liquid crystal compound together with the dichroic substance, and still more preferably a layer in which an alignment state of the liquid crystal compound and the dichroic substance is immobilized.

Hereinafter, the dichroic substance and the liquid crystal compound, which are preferably contained in the light-absorbing anisotropic layer, will be described.

### [Dichroic Substance]

In the present invention, the dichroic substance denotes a coloring agent having different absorbances depending on the direction. The dichroic substance may or may not exhibit liquid crystallinity.

The dichroic substance is not particularly limited, and examples thereof include a visible light absorbing substance (dichroic coloring agent), a light emitting substance (fluorescent substance and phosphorescent substance), an ultraviolet absorbing substance, an infrared absorbing substance, a non-linear optical substance, a carbon nanotube, and an inorganic substance (for example, quantum rod). Further, known dichroic substances (dichroic coloring agents) of the related art can be used.

Specific examples thereof include those described in paragraphs [0067] to [0071] of JP2013-228706A, paragraphs [0008] to [0026] of JP2013-227532A, paragraphs to [0015] of JP2013-209367A, paragraphs [0045] to [0058] of JP2013-14883A, paragraphs [0012] to [0029] of JP2013-109090A, paragraphs [0009] to [0017] of JP2013-101328A, paragraphs [0051] to [0065] of JP2013-37353A, paragraphs [0049] to [0073] of JP2012-63387A, paragraphs [0016] to [0018] of JP1999-305036A (JP-H11-305036A), paragraphs [0009] to [0011] of JP2001-133630A, paragraphs [0030] to [0169] of JP2011-215337A, paragraphs [0021] to [0075] of JP2010-106242A, paragraphs [0011] to [0025] of JP2010-215846A, paragraphs [0017] to [0069] of JP2011-048311A, paragraphs [0005] to [0051] of JP2011-213610A, paragraphs [0074] to [0246] of JP2011-237513A, paragraphs [0005] to [0051] of JP2016-006502A, paragraphs [0014] to [0032] of JP2018-053167A, paragraphs [0014] to [0033] of JP2020-11716A, paragraphs [0005] to [0041] of WO2016/060173A, paragraphs [0008] to [0062] of WO2016/136561A, paragraphs [0014] to [0033] of WO2017/154835A, paragraphs [0014] to [0033] of WO2017/154695A, paragraphs [0013] to [0037] of WO2017/195833A, paragraphs [0014] to [0034] of WO2018/164252A, paragraphs [0021] to [0030] of WO2018/186503A, paragraphs [0043] to [0063] of WO2019/189345A, paragraphs [0043] to [0085] of WO2019/225468A, paragraphs [0050] to [0063] of WO2020/004106A, and paragraphs [0015] to [0038] of WO2021/044843A.

As the dichroic substance, a dichroic azo coloring agent compound is preferable.

The dichroic azo coloring agent compound means an azo coloring agent compound having different absorbances depending on directions. The dichroic azo coloring agent compound may or may not exhibit liquid crystallinity. In a case where the dichroic azo coloring agent compound exhibits liquid crystallinity, the dichroic azo coloring agent compound may exhibit any of nematic liquid crystallinity or smectic liquid crystallinity. The temperature range in which the liquid crystal phase is exhibited is preferably room temperature (approximately 20° C. to 28° C.) to 300° C., and from the viewpoint of handleability and production suitability, more preferably 50° C. to 200° C.

In the present invention, from the viewpoint of tint adjustment, it is preferable to use at least one coloring agent compound (first dichroic azo coloring agent compound) having a maximal absorption wavelength in a wavelength range of 560 to 700 nm and at least one coloring agent compound (second dichroic azo coloring agent compound) having a maximal absorption wavelength in a wavelength range of 455 nm or more and less than 560 nm.

In the present invention, three or more kinds of dichroic azo coloring agent compounds may be used in combination. For example, from the viewpoint of making color of the light-absorbing anisotropic layer close to black, it is preferable to use the first dichroic azo coloring agent compound, the second dichroic azo coloring agent compound, and at least one coloring agent compound having a maximal absorption wavelength in a wavelength range of 380 nm or more and less than 455 nm (third dichroic azo coloring agent compound) in combination.

In the present invention, the dichroic azo coloring agent compound preferably has a crosslinkable group.

Examples of the crosslinkable group include a (meth)acryloyl group, an epoxy group, an oxetanyl group, and a styryl group. Among these, a (meth)acryloyl group is preferable.

The light-absorbing anisotropic layer may include a cured product (crosslinked product) of a dichroic coloring agent having a crosslinkable group (particularly, a dichroic coloring agent compound having a crosslinkable group).

The content of the dichroic substance is not particularly limited, but due to the reason that the alignment degree of the formed light-absorbing anisotropic layer is further increased, it is preferably 3% by mass or more, more preferably 8% by mass or more, still more preferably 10% by mass or more, and particularly preferably 10% to 30% by mass with respect to the total mass of the light-absorbing anisotropic layer. Further, in a case where a plurality of dichroic substances are used in combination, it is preferable that the total amount of the plurality of dichroic substances is in the above-described ranges.

### —Liquid Crystal Compound—

It is preferable that the light-absorbing anisotropic layer contains a liquid crystal compound. In this manner, the dichroic substance can be aligned with a higher alignment degree while the precipitation of the dichroic substance is suppressed.

As the liquid crystal compound, both a polymer liquid crystal compound and a low-molecular-weight liquid crystal compound can be used, and from the viewpoint of increasing the alignment degree, a polymer liquid crystal compound is preferable. In addition, the high-molecular-weight liquid crystal compound and the low-molecular-weight liquid crystal compound may be used in combination as the liquid crystal compound.

Here, “polymer liquid crystal compound” denotes a liquid crystal compound having a repeating unit in the chemical structure.

In addition, “low-molecular-weight liquid crystal compound” refers to a liquid crystal compound not including a repeating unit in a chemical structure.

Examples of the high-molecular-weight liquid crystal compound include thermotropic liquid crystalline polymers described in JP2011-237513A and high-molecular-weight liquid crystal compounds described in paragraphs [0012] to [0042] of WO2018/199096A.

Examples of the low-molecular-weight liquid crystal compound include liquid crystal compounds described in paragraphs [0072] to [0088] of JP2013-228706A. Among these, a smectic liquid crystal compound exhibiting is preferable.

From the viewpoint of further increasing the alignment degree of the dichroic substance, the liquid crystal compound is preferably a high-molecular-weight liquid crystal compound having a repeating unit represented by Formula (1) (hereinafter, also simply referred to as “repeating unit (1)”).

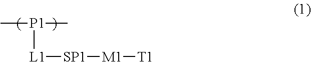

In Formula (1), P1 represents the main chain of the repeating unit, L1 represents a single bond or a divalent linking group, SP1 represents a spacer group, M1 represents a mesogen group, and T1 represents a terminal group.

Examples of the main chain of the repeating unit represented by P1 include groups represented by Formula (P1-A) to Formula (P1-D), among which a group represented by Formula (P1-A) is preferable from the viewpoint of the diversity of monomers as raw materials and the ease of handling.

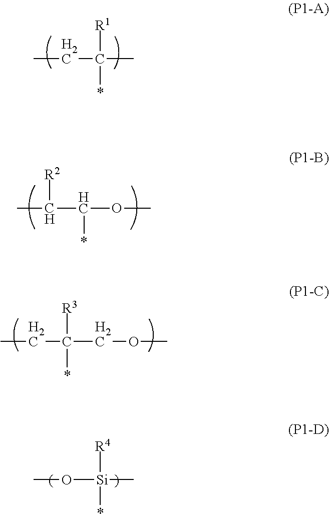

In Formulae (P1-A) to (P1-D), the symbol “*” denotes a bonding position to L1 in Formula (1).

In Formula (P1-A) to Formula (P1-D), R¹, R², R³, and R⁴ each independently represent a hydrogen atom, a halogen atom, a cyano group, an alkyl group having 1 to 10 carbon atoms, or an alkoxy group having 1 to 10 carbon atoms. The above-described alkyl group may be a linear or branched alkyl group, or an alkyl group having a cyclic structure (cycloalkyl group). In addition, the number of carbon atoms in the above-described alkyl group is preferably 1 to 5.

It is preferable that the group represented by Formula (P1-A) is one unit of a partial structure of poly(meth)acrylic acid ester, which is obtained by polymerization of (meth)acrylic acid ester.

It is preferable that the group represented by Formula (P1-B) is an ethylene glycol unit formed by ring-opening polymerization of an epoxy group of a compound having the epoxy group.

It is preferable that the group represented by Formula (P1-C) is a propylene glycol unit formed by ring-opening polymerization of an oxetane group of a compound having the oxetane group.

It is preferable that the group represented by Formula (P1-D) is a siloxane unit of a polysiloxane obtained by polycondensation of a compound having at least one of an alkoxysilyl group or a silanol group. Here, examples of the compound having at least one of an alkoxysilyl group or a silanol group include a compound having a group represented by Formula SIR¹⁴(OR¹⁵)₂—. In the formula, R¹⁴ has the same definition as that for R¹⁴ in (P1-D), and a plurality of R¹⁵'s each independently represent a hydrogen atom or an alkyl group having 1 to 10 carbon atoms.

In Formula (1), L1 represents a single bond or a divalent linking group.

Examples of the divalent linking group represented by L1 include —C(O)O—, —O—, —S—, —C(O)NR³—, —SO₂—, and —NR³R⁴—. In the formulae, R³ and R⁴ each independently represent a hydrogen atom or an alkyl group having 1 to 6 carbon atoms, which may have a substituent.

In a case where P1 is a group represented by Formula (P1-A), L1 is preferably a group represented by —C(O)O— from the viewpoint of a further increase of the alignment degree of the dichroic substance.

In a case where P1 is a group represented by any of Formulae (P1-B) to Formula (P1-D), L1 is preferably a single bond from the viewpoint of a further increase of the alignment degree of the dichroic substance.

In Formula (1), the spacer group represented by SP1 preferably contains at least one structure selected from the group consisting of an oxyethylene structure, an oxypropylene structure, a polysiloxane structure, and a fluorinated alkylene structure, from the viewpoint of easily exhibiting liquid crystallinity, availability of raw materials, and the like.

In Formula (1), the mesogenic group represented by M1 is a group showing the main skeleton of liquid crystal molecules contributing to the formation of liquid crystal. A liquid crystal molecule exhibits liquid crystallinity which is in an intermediate state (mesophase) between a crystal state and an isotropic liquid state. The mesogen group is not particularly limited, and for example, “Flussige Kristalle in Tabellen II” (VEB Deutsche Verlag fur Grundstoff Industrie, Leipzig, 1984), particularly the description on pages 7 to 16, and “Liquid Crystal Handbook” (Maruzen, 2000), particularly the description in Chapter 3, edited by the Liquid Crystal Handbook Editing Committee, can be referred to.

As the mesogen group, for example, a group having at least one cyclic structure selected from the group consisting of an aromatic hydrocarbon group, a heterocyclic group, and an alicyclic group is preferable.

From the viewpoint of a further increase of the alignment degree of the dichroic substance, the mesogenic group preferably has an aromatic hydrocarbon group, more preferably 2 to 4 aromatic hydrocarbon groups, and even more preferably 3 aromatic hydrocarbon groups.

In Formula (1), examples of the terminal group represented by T1 include a hydrogen atom, a halogen atom, a cyano group, a nitro group, a hydroxy group, an alkyl group having 1 to 10 carbon atoms, an alkoxy group having 1 to 10 carbon atoms, an alkylthio group having 1 to 10 carbon atoms, an alkoxycarbonyloxy group having 1 to 10 carbon atoms, an alkoxycarbonyl group having 1 to 10 carbon atoms (ROC(O)—: R represents an alkyl group), an acyloxy group having 1 to 10 carbon atoms, an acylamino group having 1 to 10 carbon atoms, an alkoxycarbonylamino group having 1 to 10 carbon atoms, a sulfonylamino group having 1 to 10 carbon atoms, a sulfamoyl group having 1 to 10 carbon atoms, a carbamoyl group having 1 to 10 carbon atoms, a sulfinyl group having 1 to 10 carbon atoms, a ureido group having 1 to 10 carbon atoms, and a (meth)acryloyloxy group-containing group. Examples of the (meth)acryloyloxy group-containing group include a group represented by -L-A (L represents a single bond or a linking group, specific examples of the linking group are the same as those for L1 and SP1 described above, and A represents a (meth)acryloyloxy group).

From the viewpoint of further increasing the alignment degree of the dichroic substance, T1 is preferably an alkoxy group having 1 to 10 carbon atoms, more preferably an alkoxy group having 1 to 5 carbon atoms, and still more preferably a methoxy group.

These terminal groups may be further substituted with these groups or the polymerizable group described in JP2010-244038A.

T1 is preferably a polymerizable group from the viewpoint of further enhancing the adhesiveness to the adjacent layer and improving the cohesive force of the film.

The polymerizable group is not particularly limited, but is preferably a polymerizable group which is radically polymerizable or cationically polymerizable.

As the radically polymerizable group, a generally known radically polymerizable group can be used, and suitable examples thereof include an acryloyl group and a methacryloyl group. In this case, an acryloyl group is generally known to have a high polymerization rate and therefore the acryloyl group is preferable from the viewpoint of improving productivity. However, a methacryloyl group can also be used as the polymerizable group.

As the cationically polymerizable group, generally known cationically polymerizable groups can be used, and specific examples thereof include an alicyclic ether group, a cyclic acetal group, a cyclic lactone group, a cyclic thioether group, a spiroorthoester group, and a vinyloxy group. Among these, an alicyclic ether group or a vinyloxy group is preferable, and an epoxy group, an oxetanyl group, or a vinyloxy group is preferable.

From the viewpoint of a further increase of the alignment degree of the dichroic substance, the weight-average molecular weight (Mw) of the polymer liquid crystal compound having a repeating unit represented by Formula (1) is 1,000 to 500,000 and more preferably 2,000 to 300,000. In a case where the Mw of the high molecular weight liquid crystal compound is within the above range, the high molecular weight liquid crystal compound can be easily handled.

In particular, from the viewpoint of suppressing cracking during coating, the weight-average molecular weight (Mw) of the high-molecular-weight liquid crystal compound is preferably 10,000 or more and more preferably 10,000 to 300,000.

In addition, from the viewpoint of temperature latitude of the alignment degree, the weight-average molecular weight (Mw) of the high-molecular-weight liquid crystal compound is preferably less than 10,000 and more preferably 2,000 or more and less than 10,000.

Here, the weight-average molecular weight and the number-average molecular weight in the present invention are values measured by gel permeation chromatography (GPC).
Solvent (eluant): N-methylpyrrolidone
Device name: TOSOH HLC-8220GPC
Column: Connect and use three of TOSOH TSKgel Super AWM-H (6 mm×15 cm)
Column temperature: 25° C.
Sample Concentration: 0.1% by mass
Flow rate: 0.35 mL/min
Calibration curve: TSK standard polystyrene manufactured by TOSOH Corporation, calibration curves of 7 samples with Mw of 2,800,000 to 1,050 (Mw/Mn=1.03 to 1.06) are used

The liquid crystal compound is preferably a liquid crystal compound having reverse wavelength dispersibility.

In the present specification, the expression “having reverse wavelength dispersibility” means that a retardation film produced using the liquid crystal compound satisfies relationships represented by Expression (X1) and (X2).

$$Re ( 450 ) / Re ( 550 ) < 1 \qquad ( X1 )$$

$$1 < Re ( 630 ) / Re ( 550 ) \qquad ( X2 )$$

The polymerizable liquid crystal compound having reverse wavelength dispersibility is not particularly limited as long as a film having reverse wavelength dispersibility can be formed, and examples thereof include a compound represented by Formula (I) described in JP2008-297210A (particularly, compounds described in paragraphs [0034] to [0039]), a compound represented by Formula (1) described in JP2010-084032A (particularly, compounds described in paragraphs [0067] to [0073]), a compound represented by General Formula (1) described in JP2019-73496A (particularly compounds described in paragraphs [0017] to [0124]), and a compound represented by Formula (1) described in JP2016-081035A (particularly, compounds described in paragraphs [0043] to [0055]).

The polymerizable group is not particularly limited, and is preferably a polymerizable group capable of radical polymerization or cationic polymerization.

As a radically polymerizable group, known radically polymerizable groups are mentioned, and an acryloyl group or a methacryloyl group is preferable. It has been known that an acryloyl group generally has a high polymerization rate, and from the viewpoint of improving productivity, an acryloyl group is preferable. However, a methacryloyl group can also be used as the polymerizable group for highly birefringent liquid crystals.

As a cationically polymerizable group, known cationically polymerizable groups are mentioned, and examples thereof include an alicyclic ether group, a cyclic acetal group, a cyclic lactone group, a cyclic thioether group, a spiroorthoester group, and a vinyloxy group. Among these, an alicyclic ether group or a vinyloxy group is preferable, and an epoxy group, an oxetanyl group, or a vinyloxy group is more preferable.

Examples of a particularly preferred polymerizable group include a polymerizable group represented by any one of Formulae (P-1) to (P-20).

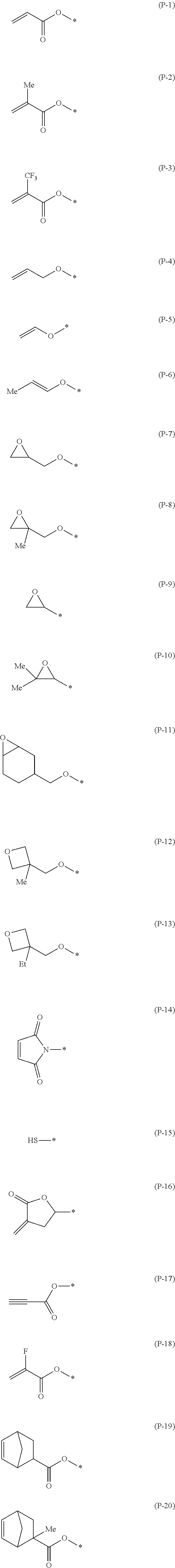

The liquid crystal compound may have forward wavelength dispersibility.

In the present specification, the “have reverse wavelength dispersibility” means that a phase difference film produced using this liquid crystal compound satisfies relationships of Expression (Y1) and (Y2).

$$Re ( 450 ) / Re ( 550 ) > 1 \qquad ( Y1 )$$

$$1 > Re ( 630 ) / Re ( 550 ) \qquad ( Y2 )$$

The liquid crystal compound is also preferably a polymerizable liquid crystal compound which has forward wavelength dispersion and has two polymerizable groups P¹ and P² and three or more rings B¹ selected from the group consisting of an aromatic ring and an alicyclic ring and existing on a bond connecting the polymerizable groups P¹ and P².

The two polymerizable groups P¹ and P² included in the polymerizable liquid crystal compound may be the same or different from each other, and the three or more rings B¹ included in the polymerizable liquid crystal compound are the same or different from each other.

The polymerizable groups P¹ and P² included in the polymerizable liquid crystal compound are not particularly limited, but are preferably polymerizable groups capable of radical polymerization or cationic polymerization.

A known radically polymerizable group can be used as the radically polymerizable group, and suitable examples thereof include an acryloyloxy group and a methacryloyloxy group. In this case, it has been known that an acryloyloxy group tends to have a higher polymerization rate, and from the viewpoint of improving productivity, an acryloyloxy group is preferable. However, a methacryloyloxy group can also be used as the polymerizable group.

As the cationically polymerizable group, a well-known cationically polymerizable group can be used, and specific examples thereof include an alicyclic ether group, a cyclic acetal group, a cyclic lactone group, a cyclic thioether group, a spiroorthoester group, and a vinyloxy group. Among these, an alicyclic ether group or a vinyloxy group is preferable, and an epoxy group, an oxetanyl group, or a vinyloxy group is more preferable.

Particularly preferable examples of the polymerizable group include a polymerizable group represented by any of Formulae (P-1) to (P-20).

The polymerizable liquid crystal compound may have three or more polymerizable groups. In a case where the polymerizable liquid crystal compound has three or more polymerizable groups, a polymerizable group other than the polymerizable groups P¹ and P² described above is not particularly limited, and examples thereof include the same ones as the radically polymerizable or cationically polymerizable groups described above, including suitable aspects thereof.

The number of polymerizable groups included in the polymerizable liquid crystal compound is preferably 2 to 4, and it is more preferable to have only two of the polymerizable groups P1 and P2.

The polymerizable liquid crystal compound has three or more rings B¹ selected from the group consisting of an aromatic ring which may have a substituent and an alicyclic ring which may have a substituent, the ring B¹ existing on a bond connecting the polymerizable groups P1 and P2.

Here, the description that the ring B¹ “existing on a bond connecting the polymerizable groups P¹ and P²” means that the ring B¹ constitutes a part of the portion required for directly linking the polymerizable groups P¹ and P².

The polymerizable liquid crystal compound may have a portion other than the portion required for directly linking the polymerizable groups P¹ and P² (hereinafter, also described as “side chain”), and a ring structure forming a part of the side chain is not included in the ring B¹.

Examples of the aromatic ring which may have a substituent, which is one aspect of the ring B¹, include an aromatic ring having 5 to 20 ring members, which may have a substituent.

Examples of the aromatic ring having 5 to 20 ring members include aromatic hydrocarbon rings such as a benzene ring, a naphthalene ring, an anthracene ring, and a phenanthrene ring; and aromatic heterocyclic rings such as a furan ring, a pyrrole ring, a thiophene ring, a pyridine ring, a thiazole ring, a benzothiazole ring, a quinoline ring, an isoquinoline ring, a quinoxaline ring, and a quinazoline ring.

Examples of the substituent which may be included in the aromatic ring which is one aspect of the ring B¹ include an alkyl group, an alkoxy group, an alkylcarbonyl group, an alkoxycarbonyl group, an alkylcarbonyloxy group, an alkylamino group, a dialkylamino group, an alkylamide group, an alkenyl group, an alkynyl group, a halogen atom, a cyano group, a nitro group, an alkylthiol group, and an N-alkyl carbamate group.

In particular, an alkyl group, an alkoxy group, an alkoxycarbonyl group, an alkylcarbonyloxy group, or a halogen atom is preferable.

The alkyl group is preferably a linear, branched, or cyclic alkyl group having 1 to 18 carbon atoms, more preferably an alkyl group having 1 to 8 carbon atoms (for example, a methyl group, an ethyl group, a propyl group, an isopropyl group, an n-butyl group, an isobutyl group, a sec-butyl group, a t-butyl group, and a cyclohexyl group), still more preferably an alkyl group having 1 to 4 carbon atoms, and particularly preferably a methyl group or an ethyl group.

The alkoxy group is preferably an alkoxy group having 1 to 18 carbon atoms, more preferably an alkoxy group having 1 to 8 carbon atoms (for example, a methoxy group, an ethoxy group, an n-butoxy group, and a methoxyethoxy group), still more preferably an alkoxy group having 1 to 4 carbon atoms, and particularly preferably a methoxy group or an ethoxy group.

Examples of the alkoxycarbonyl group include a group in which an oxycarbonyl group (—O—CO— group) is bonded to the alkyl group exemplified above. A methoxycarbonyl group, an ethoxycarbonyl group, an n-propoxycarbonyl group, or an isopropoxycarbonyl group is preferable, and a methoxycarbonyl group is more preferable.

Examples of the alkylcarbonyloxy group include a group in which a carbonyloxy group (—CO—O— group) is bonded to the alkyl group exemplified above. A methylcarbonyloxy group, an ethylcarbonyloxy group, an n-propylcarbonyloxy group, or an isopropylcarbonyloxy group is preferable, and a methylcarbonyloxy group is more preferable.

Examples of the halogen atom include a fluorine atom, a chlorine atom, a bromine atom, and an iodine atom, and a fluorine atom or a chlorine atom is preferable.

Examples of the alicyclic ring which may have a substituent, which is one aspect of the ring B¹, include a divalent alicyclic hydrocarbon group having 5 to 20 carbon atoms, which may have a substituent, and a heterocyclic ring in which one or more —CH₂-'s constituting an alicyclic hydrocarbon group having 5 to 20 carbon atoms are substituted with —O—, —S—, or —NH—.

The divalent alicyclic hydrocarbon group having 5 to 20 carbon atoms is preferably a 5-membered ring or a 6-membered ring. In addition, the alicyclic hydrocarbon group may be saturated or unsaturated, but a saturated alicyclic hydrocarbon group is preferable. As the divalent alicyclic hydrocarbon group, for example, the description of paragraph of JP2012-021068A can be referred to, the contents of which are incorporated herein by reference.

The alicyclic ring which is one aspect of the ring B¹ is preferably a cycloalkane ring having 5 to 20 carbon atoms. Examples of the cycloalkane ring having 5 to 20 carbon atoms include a cyclohexane ring, a cycloheptane ring, a cyclooctane ring, a cyclododecane ring, and a cycloicosane ring. Among these, a cyclohexane ring is preferable, a 1,4-cyclohexylene group is more preferable, and a trans-1,4-cyclohexylene group is still more preferable.

Examples of the substituent which may be included in the alicyclic ring which is one aspect of the ring B¹ include the same substituents as the substituent which may be included in the aromatic ring which is one aspect of the ring B¹ described above, including suitable aspects thereof.

The alicyclic ring which is one aspect of the ring B¹ preferably has no substituent.

As the ring B¹, the polymerizable liquid crystal compound preferably has at least one aromatic ring which may have a substituent, and more preferably has at least one group represented by Formula (III) described later.

In addition, as the ring B¹, the polymerizable liquid crystal compound preferably has at least one cyclohexane ring, more preferably has at least one 1,4-cyclohexylene group, and still more preferably has at least one trans-1,4-cyclohexylene group.

That is, as the ring B¹, the polymerizable liquid crystal compound preferably has a combination consisting of at least one aromatic ring (more preferably, the group represented by Formula (III) described later) and at least one cyclohexane ring (more preferably, two to four 1,4-cyclohexylene groups).

In the polymerizable liquid crystal compound, the number of rings B¹ existing on the bond connecting the polymerizable groups P¹ and P² is not particularly limited, but from the viewpoint of alignment stability of the liquid crystal compound, the number thereof is preferably 3 to 7, more preferably 4 to 6, and still more preferably 5.

—Other Components—

The light-absorbing anisotropic layer may contain other components in addition to the components described above. Examples of other components include a vertical alignment agent and a leveling agent.

Examples of the vertical alignment agent include a boronic acid compound and an onium salt.

A compound represented by Formula (A) is preferable as the boronic acid compound.

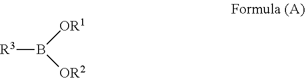

In Formula (A), R¹ and R² each independently represent a hydrogen atom, a substituted or unsubstituted aliphatic hydrocarbon group, a substituted or unsubstituted aryl group, or a substituted or unsubstituted heterocyclic group.

R³ represents a substituent containing a (meth)acrylic group.

Specific examples of the boronic acid compound include a boronic acid compound represented by General Formula (I) described in paragraphs to of JP2008-225281A.

A compound represented by Formula (B) is preferable as the onium salt.

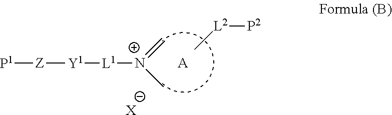

In Formula (B), the ring A represents a quaternary ammonium ion consisting of a nitrogen-containing heterocyclic ring. X-represents an anion. L1 represents a divalent linking group. L2 represents a single bond or a divalent linking group. Y1 represents a divalent linking group having a 5- or 6-membered ring as a partial structure. Z represents a divalent linking group having an alkylene group having 2 to 20 carbon atoms as a partial structure. Further, P¹ and P² each independently represent a monovalent substituent having a polymerizable ethylenically unsaturated bond.

Specific examples of the onium salt include the onium salts described in paragraphs [0052] to [0058] of JP2012-208397A, the onium salts described in paragraphs [0024] to [0055] of JP2008-026730A, and the onium salts described in JP2002-037777A.

In a case where the light-absorbing anisotropic layer contains a vertical alignment agent, the content of the vertical alignment agent is preferably in a range of 0.1% to 400% by mass and more preferably in a range of 0.5% to 350% by mass with respect to the total mass of the liquid crystal compound.

The vertical alignment agent may be used alone or in combination of two or more kinds thereof. In a case where two or more kinds of vertical alignment agents are used, the total amount thereof is preferably within the above-described range.

The light-absorbing anisotropic layer may contain a leveling agent. In a case where a composition for forming a light-absorbing anisotropic layer (light-absorbing anisotropic layer) to be described later contains a leveling agent, surface roughening due to the drying air applied to the surface of the light-absorbing anisotropic layer is suppressed, and the dichroic substance is more uniformly aligned.

The leveling agent is not particularly limited, but a leveling agent containing a fluorine atom (fluorine-based leveling agent) or a leveling agent containing a silicon atom (silicon-based leveling agent) is preferable, and a fluorine-based leveling agent is more preferable.

Examples of the fluorine-based leveling agent include fatty acid esters of polyvalent carboxylic acid, in which a part of a fatty acid is substituted with a fluoroalkyl group, and polyacrylates having a fluoro substituent.

Specific examples of the leveling agent include compounds described in paragraphs [0046] to [0052] of JP2004-331812A and compounds described in paragraphs [0038] to [0052] of JP2008-257205A.

In a case where the light-absorbing anisotropic layer contains a liquid crystal compound and a leveling agent, the content of the leveling agent is preferably in a range of 0.001% to 10% by mass and more preferably in a range of 0.01% to 5% by mass with respect to the total mass of the liquid crystal compound.

The leveling agents may be used alone or in combination of two or more kinds thereof. In a case where two or more kinds of leveling agents are used, the total amount thereof is preferably within the above-described range.

### <Composition for Forming Light-Absorbing Anisotropic Layer>

The light-absorbing anisotropic layer is preferably formed of a composition for forming a light-absorbing anisotropic layer containing a dichroic substance and a liquid crystal compound.

The composition for forming a light-absorbing anisotropic layer preferably contains a solvent and the like to be described later in addition to the dichroic substance and the liquid crystal compound, and may further contain other components described above.

Examples of the dichroic substance contained in the composition for forming the light-absorbing anisotropic layer include a dichroic substance that can be contained in the light-absorbing anisotropic layer.

It is preferable that the content of the dichroic substance with respect to the total solid content mass of the composition for forming a light-absorbing anisotropic layer is the same as the content of the dichroic substance with respect to the total mass of the light-absorbing anisotropic layer.

Here, “total solid content in the composition for forming a light-absorbing anisotropic layer” denotes components excluding the solvent, and specific examples of the solid content include the dichroic substance, the liquid crystal compound, and the above-described other components.

The liquid crystal compound and other components which can be contained in the composition for forming a light-absorbing anisotropic layer are respectively the same as the liquid crystal compound and other components which can be contained in the light-absorbing anisotropic layer.

It is preferable that the content of the liquid crystal compound and the content of other components with respect to the total solid content mass of the composition for forming a light-absorbing anisotropic layer be respectively the same as the content of the liquid crystal compound and the content of other components with respect to the total mass of the light-absorbing anisotropic layer.

From the viewpoint of the workability, it is preferable that the composition for forming a light-absorbing anisotropic layer contains a solvent.

Examples of the solvent include organic solvents such as ketones, ethers, aliphatic hydrocarbons, alicyclic hydrocarbons, aromatic hydrocarbons, carbon halides, esters, alcohols, cellosolves, cellosolve acetates, sulfoxides, amides, and heterocyclic compounds, and water.

These solvents may be used alone or in combination of two or more kinds thereof.

Among these solvents, organic solvents are preferable, and carbon halides or ketones are more preferable.

In a case where the composition for forming a light-absorbing anisotropic layer contains a solvent, the content of the solvent is preferably 80% to 99% by mass, more preferably 83% to 97% by mass, and still more preferably 85% to 95% by mass with respect to the total mass of the composition for forming a light-absorbing anisotropic layer.

The composition for forming a light-absorbing anisotropic layer may contain a polymerization initiator.

The polymerization initiator is not particularly limited, but a photosensitive compound, that is, a photopolymerization initiator is preferable.

Commercially available products can also be used as such a photopolymerization initiator, and examples thereof include IRGACURE 184, IRGACURE 907, IRGACURE 369, IRGACURE 651, IRGACURE 819, IRGACURE OXE-01, and IRGACURE OXE-02 (all manufactured by BASF SE).

The polymerization initiators may be used alone or in combination of two or more kinds thereof.

In a case where the composition for forming a light-absorbing anisotropic layer contains a polymerization initiator, the content of the polymerization initiator is preferably in a range of 0.01% to 30% by mass and more preferably in a range of 0.1% to 15% by mass with respect to the total solid content of the composition for forming a light-absorbing anisotropic layer.

### —Optical Absorption Anisotropic Layer Producing Method—

The method of producing the light-absorbing anisotropic layer is not particularly limited, but a method including a step of coating an alignment film with the composition for forming a light-absorbing anisotropic layer containing a dichroic substance and a liquid crystal compound to form a coating film (hereinafter, also referred to as “coating film forming step”) and a step of aligning a liquid crystal component contained in the coating film (hereinafter, also referred to as “aligning step”) in this order (hereinafter, also referred to as “present production method”) is preferable from the viewpoint of a further increase of the alignment degree of the dichroic substance.

Further, the liquid crystal component is a component containing not only the liquid crystal compound described above but also a dichroic substance having liquid crystallinity.

Hereinafter, each of the steps will be described.

The coating film-forming step is a step of applying the above-described composition for forming a light-absorbing anisotropic layer onto the alignment film to form a coating film.

The alignment film is easily coated with the composition for forming a light-absorbing anisotropic layer by using the composition for forming a light-absorbing anisotropic layer which contains the above-described solvent or using a liquid-like material such as a melt obtained by heating the composition for forming a light-absorbing anisotropic layer.

Examples of a method of applying the composition for forming a light-absorbing anisotropic layer include known methods such as a roll coating method, a gravure printing method, a spin coating method, a wire bar coating method, an extrusion coating method, a direct gravure coating method, a reverse gravure coating method, a die coating method, a spraying method, and an ink jet method.

The alignment film may be any film as long as it is a film in which the liquid crystal component which can be contained in the composition for forming a light-absorbing anisotropic layer is aligned.

The alignment film can be provided by methods such as rubbing treatment of an organic compound (preferably a polymer) on a film surface, oblique vapor deposition of an inorganic compound, formation of a layer having microgrooves, or accumulation of an organic compound (for example, ω-tricosanoic acid, dioctadecylmethylammonium chloride, or methyl stearate) by the Langmuir-Blodgett method (LB film). Furthermore, there have been known alignment films having an aligning function imparted thereto by applying an electrical field, applying a magnetic field, or light irradiation. Among these, an alignment film formed by a rubbing treatment is preferable in view of easy control of a pretilt angle of the alignment film, and a photo-alignment film formed by light irradiation is also preferable in view of alignment uniformity in the present invention.

As the photo-alignment film, a photo-alignment film containing an azobenzene coloring agent, polyvinyl cinnamate, or the like is used.

The dichroic substance in the light-absorbing anisotropic layer can be aligned by irradiating a photo-alignment layer with ultraviolet rays in an oblique direction at an angle to the normal direction of the photo-alignment layer, generating anisotropy with an inclination with respect to the normal direction of the photo-alignment layer, and aligning the light-absorbing anisotropic layer thereon.

In addition, a liquid crystal layer in which the liquid crystal compound is hybrid-aligned can also be used as the alignment film.

The aligning step is a step of aligning the liquid crystal component (particularly, the dichroic substance) contained in the coating film. In the aligning step, the dichroic substance is considered to be aligned along the liquid crystal compound aligned by the alignment film.

The aligning step may have a drying treatment. Components such as a solvent can be removed from the coating film by performing the drying treatment. The drying treatment may be performed by a method of allowing the coating film to stand at room temperature for a predetermined time (for example, natural drying) or a method of heating the coating film and/or blowing air to the coating film.

The aligning step preferably has a heating treatment. In this manner, the dichroic substance contained in the coating film is further aligned, and the alignment degree of the dichroic substance is further increased.

From the viewpoint of the manufacturing suitability, the heat treatment is performed at a temperature of preferably 10° C. to 250° C. and more preferably 25° C. to 190° C. Further, the heating time is preferably 1 to 300 seconds and more preferably 1 to 60 seconds.

The aligning step may include a cooling treatment performed after the heating treatment. The cooling treatment is a treatment of cooling the heated coating film to room temperature (20° C. to 25° C.). As a result, the alignment of the dichroic substance contained in the coating film is further fixed, and the alignment degree of the dichroic substance is further increased. The cooling unit is not particularly limited, and the cooling can be performed by a known method.

The light-absorbing anisotropic layer according to the embodiment of the present invention can be obtained by performing the above-described steps.

The present manufacturing method may include a step of curing the light-absorbing anisotropic layer after the above-described aligning step (hereinafter, also referred to as “curing step”).

For example, the curing step is performed by heating and/or light irradiation (exposure). Among these, it is preferable that the curing step is performed by irradiating the EO layer with light.

As a light source used for curing, various light sources for infrared light, visible light, ultraviolet light, or the like can be used, but a light source for ultraviolet light is preferable. In addition, ultraviolet rays may be applied while the light absorption anisotropic film is heated during the curing, or ultraviolet rays may be applied through a filter which transmits only a specific wavelength.

Further, the exposure may be performed under a nitrogen atmosphere. In a case where curing of the light-absorbing anisotropic layer proceeds by radical polymerization, inhibition of the polymerization by oxygen is reduced, and thus the exposure is preferably performed under a nitrogen atmosphere.

The thickness of the light-absorbing anisotropic layer is not particularly limited, but from the viewpoint that the effects of the present invention are more excellent, the thickness is preferably 0.5 to 7 μm, and more preferably 1.0 to 3 μm.

### (Retardation Layer)

The film according to the first embodiment of the present invention includes at least one or more retardation layers between two light-absorbing anisotropic layers.

In the film according to the first embodiment of the present invention, it is preferable that two or more retardation layers are included.

The retardation layer is preferably a retardation layer having a slow axis in an in-plane direction, and it is preferably a λ/2 plate. In the present specification, the λ/2 plate refers to a retardation layer in which an in-plane phase difference is approximately ½ of a wavelength, and specifically, refers to a retardation layer in which an in-plane phase difference Re(550) at a wavelength of 550 nm is 220 to 320 nm.

A material for forming the retardation layer is not particularly limited, and examples thereof include a retardation layer containing a liquid crystal compound and a stretched film. Among these, as the retardation layer, a retardation layer containing a liquid crystal compound is preferable.

In general, the liquid crystal compound can be classified into a rod-like type and a disk-like type according to the shape thereof. Furthermore, each type includes a low-molecular-type and a high-molecular-type. The high molecular weight generally refers to having a polymerization degree of 100 or more (Polymer Physics-Phase Transition Dynamics, Masao Doi, page 2, Iwanami Shoten, 1992). In the present invention, any liquid crystal compound can be used, and a rod-like liquid crystal compound or a discotic liquid crystal compound (disk-like liquid crystal compound) is preferable. In addition, a liquid crystal compound which is a monomer or has a relatively low molecular weight with a degree of polymerization of less than 100 is preferable.

In addition, examples of the polymerizable group of the polymerizable liquid crystal compound include an acryloyl group, a methacryloyl group, an epoxy group, and a vinyl group.

By polymerizing such a polymerizable liquid crystal compound, the alignment of the liquid crystal compound can be immobilized. After immobilizing the liquid crystal compound by polymerization, it is no longer necessary to exhibit liquid crystallinity.

As the rod-like liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles are preferably used. These rod-like liquid crystal compounds are fixed by introducing a polymerizable group to the terminal structure of the rod-like liquid crystal compound (the same as in the disk-like liquid crystal described later) and using a polymerization and curing reaction. As a specific example, curing a polymerizable nematic rod-like liquid crystal compound with ultraviolet rays is described in JP2006-209073A. In addition, as well as the above-described low-molecular-weight liquid crystal compound, a high-molecular-weight liquid crystal compound can also be used. The high-molecular-weight liquid crystal compound is a polymer having a side chain corresponding to the above-described low-molecular-weight liquid crystal compound. JP1993-053016A (JP-H5-053016A) or the like describes an optical compensation sheet formed of a polymer liquid crystal compound.

The disk-like liquid crystal compound includes benzene derivatives described in C. Destrade et al.'s study report, “Mol. Cryst.”, vol. 71, page 111 (1981); truxene derivatives described in C. Destrade et al.'s study report, “Mol. Cryst.”, vol. 122, page 141 (1985) and “Physics lett, A”, vol. 78, page 82 (1990); cyclohexane derivatives described in B. Kohne et al.'s study report, “Angew. Chem.”, vol. 96, page 70 (1984); and azacrown-based or phenyl acetylene-based macrocycles described in J. M. Lehn et al.'s study report, “J. Chem. Commun.”, page 1794 (1985) and J. Zhang et al.'s study report, “J. Am. Chem. Soc.”, vol. 116, page 2655 (1994).

A compound in which molecules of a disk-like liquid crystal compound exhibit liquid crystallinity with a structure in which a linear alkyl group, alkoxy group, or substituted benzoyloxy group is radially substituted as a side chain of mother nuclei at the centers of the molecules is also included. A compound in which molecules or molecular aggregates have rotation symmetry and to which certain alignment can be imparted is preferable. A retardation layer formed from a composition containing a disk-like liquid crystal compound does not need to exhibit liquid crystallinity in a state of being finally included in the retardation layer. For example, in a case where low-molecular-weight disk-like liquid crystalline molecules having a group which reacts with heat or light are polymerized by heating or light irradiation to increase the molecular weight, the liquid crystallinity is lost, but a retardation layer containing such a polymer compound can also be used in the present invention. Preferable examples of the disk-like liquid crystal compound include compounds described in JP1996-050206A (JP-H8-050206A). In addition, the polymerization of the disk-like liquid crystalline molecules is described in JP1996-027284A (JP-H8-027284A).

In order to fix the disk-like liquid crystalline molecules by polymerization, it is necessary to bond a polymerizable group as a substituent to the disk-like cores of the disk-like liquid crystalline molecules. A compound in which the disk-like core and the polymerizable group are bonded via a linking group is preferable, whereby the compound can maintain the alignment state even under the polymerization reaction. Examples thereof include compounds described in paragraph Nos. [0051] to [0168] of the specification of JP2000-155216A.

In the film according to the first embodiment of the present invention, it is preferable that at least one retardation layer is a layer formed of a composition containing a disk-like liquid crystal compound. In a case where the film includes two or more retardation layers, it is also preferable that at least one retardation layer is a layer formed of a composition containing a disk-like liquid crystal compound and at least one retardation layer is a layer formed of a composition containing a rod-like liquid crystal compound. In addition, in a case where the film includes two or more retardation layers, at least two retardation layers may be layers formed of a composition containing a disk-like liquid crystal compound.

In the film according to the first embodiment of the present invention, from the reason that a change in tint can be suppressed, it is also preferable that at least one of the retardation layers is a layer formed of a composition containing a rod-like liquid crystal compound having reverse wavelength dispersibility.

Examples of such a rod-like liquid crystal compound having reverse wavelength dispersibility include those (particularly, a polymerizable liquid crystal compound having reverse wavelength dispersibility) described as an optional liquid crystal compound contained in the light-absorbing anisotropic layer described above.

In addition, in a case where the film includes two or more retardation layers, from the reason that the light shielding properties of light incident from an oblique direction can be enhanced and a change in tint can be suppressed, it is also preferable that at least one retardation layer is a layer formed of a composition containing a rod-like liquid crystal compound and at least one retardation layer different from the layer formed of the composition containing the rod-like liquid crystal compound is a layer formed of a composition containing a disk-like liquid crystal compound. In addition, it is also preferable that at least one retardation layer is a layer formed of a composition containing a rod-like liquid crystal compound having reverse wavelength dispersibility and at least one retardation layer different from the layer formed of the composition containing the rod-like liquid crystal compound having reverse wavelength dispersibility is a layer formed of a composition containing a disk-like liquid crystal compound. Examples of such a rod-like liquid crystal compound or rod-like liquid crystal compound having reverse wavelength dispersibility include those (particularly, a polymerizable liquid crystal compound having reverse wavelength dispersibility and a polymerizable liquid crystal compound having forward wavelength dispersibility) described as an optional liquid crystal compound contained in the light-absorbing anisotropic layer described above.

In the film according to the first embodiment of the present invention, in a case where the retardation layer is a layer formed of a composition containing a liquid crystal compound, examples of components other than the liquid crystal compound contained in the composition include components other than the dichroic substance contained in the light-absorbing anisotropic layer described above.

Examples of the method of forming the retardation layer include a method in which a composition containing a liquid crystal compound is used for forming a desired alignment state, and then the alignment state is fixed by polymerization.

Here, polymerization conditions are not particularly limited, but ultraviolet rays are preferably used in the polymerization by light irradiation. An irradiation amount is preferably 10 mJ/cm² to 50 J/cm², more preferably 20 mJ/cm² to 5 J/cm², still more preferably 30 mJ/cm² to 3 J/cm², and particularly preferably 50 to 1,000 mJ/cm². In order to promote the polymerization reaction, the treatment may be performed under heating conditions.

A thickness of the retardation layer is not particularly limited, but is preferably 0.1 to 20 μm, more preferably 0.5 to 15 μm, and still more preferably 1 to 10 μm.

In the film according to the first embodiment of the present invention, in a case where two retardation layers are included, from the reason that light shielding properties of light incident from an oblique direction are further improved, it is preferable that the two retardation layers are in direct contact with each other or are laminated through only at least one of an adhesive layer, a pressure sensitive adhesive layer, or an alignment film, which will be described later.

Here, the expression “laminated via only at least one” means that in a case of using any one of an adhesive layer, a pressure sensitive adhesive layer, or an alignment film, the laminate is formed via only one of them, and in a case of using any two (for example, a pressure sensitive adhesive layer and an alignment film) of an adhesive layer, a pressure sensitive adhesive layer, or an alignment film, the laminate is formed via only two of them.

In the aspect shown in FIG. 1, an angle between an in-plane slow axis direction of the first retardation layer 14a and an in-plane slow axis direction of the second retardation layer 14b is 45°. In the film according to the first embodiment of the present invention, in a case where two retardation layers are included, an angle between an in-plane slow axis direction of one retardation layer and an in-plane slow axis direction of the other retardation layer is preferably within a range of 45°±10°, more preferably within a range of 45°±8°, and still more preferably within a range of 45°±5°.

The retardation layer may include a retardation plate (other retardation plate) other than the λ/2 plate. Preferred examples of the other retardation plate include a positive C-plate.

The positive C-plate refers to an optical member in which refractive indices nx, ny, and nz satisfy the following Expression (2).

$$nz > nx {}_{}^{\cdot } {=}_{\cdot }^{} ny \qquad Expression ( 2 )$$

For example, in a case where the retardation layer includes a λ/2 plate, the positive C-plate can provide more advanced optical compensation for light incident from an oblique direction.

### (Alignment Film)

In the first embodiment of the film according to the present invention, in a case where the above-described light-absorbing anisotropic layer and retardation layer are layers formed of a composition containing a liquid crystal compound, an alignment film may be provided as an adjacent layer.

Specific examples of the alignment film include a layer formed of polyvinyl alcohol, polyimide, or the like, which has been or has not been subjected to a rubbing treatment; and a photo-alignment film formed of polyvinyl cinnamate, an azo-based dye, or the like, which has been or has not been subjected to a polarizing exposure treatment.

The thickness of the alignment film is preferably 0.01 to 10 μm, and more preferably 0.01 to 1 μm.

### (Pressure-Sensitive Adhesive Layer)

The first embodiment of the film according to the present invention may include a pressure sensitive adhesive layer.

The pressure sensitive adhesive layer is preferably a transparent and optically isotropic adhesive similar to that used in a typical image display device, and a pressure sensitive type adhesive is typically used.

The pressure sensitive adhesive layer may be blended with appropriate additives such as a crosslinking agent (for example, an isocyanate-based crosslinking agent and an epoxy-based crosslinking agent), a viscosity imparting agent (for example, a rosin derivative resin, a polyterpene resin, a petroleum resin, and an oil-soluble phenol resin), a plasticizer, a filler, an antiaging agent, a surfactant, an ultraviolet absorbing agent, a light stabilizer, and an antioxidant in addition to a parent material (pressure sensitive adhesive), conductive particles, and thermally expandable particles used as necessary.

In a case where the first embodiment of the film according to the present invention includes an adhesive layer, from the viewpoint that the maximum height difference of undulation is likely to be reduced, a film thickness of the adhesive layer is preferably 20 μm or less, more preferably 10 μm or less, still more preferably 8 μm or less, and particularly preferably 5 μm or less. A lower limit of the film thickness of the adhesive layer is not particularly limited, but is, for example, 0.1 μm or more in many cases.

From the viewpoint that the maximum height difference of undulation is likely to be reduced, a storage elastic modulus of the adhesive layer is preferably 0.6 MPa to 20 MPa.

The storage elastic modulus of the adhesive layer refers to a value measured under conditions of a frequency of 1 Hz and 25° C. using a dynamic viscoelasticity measuring device (DVA-200) manufactured by IT Measurement Control Co., Ltd.

From the viewpoint that the maximum height difference of undulation is likely to be reduced, a film thickness of the first embodiment of the film according to the present invention is preferably 50 to 400 μm.

In the first embodiment of the film according to the present invention, two or more adhesive layers may be included. For example, in the aspect shown in FIG. 1, the adhesive layer may be disposed between the first light-absorbing anisotropic layer 12a and the first retardation layer 14a, between the first retardation layer 14a and the second retardation layer 14b, and between the second retardation layer 14b and the second light-absorbing anisotropic layer 12b, or may be disposed between two of the three.

### (Adhesive Layer)

The film according to the first embodiment of the present invention may have an adhesive layer.

The adhesive layer exhibits adhesiveness by drying, reaction, and the like after bonding.

A polyvinyl alcohol-based adhesive (PVA-based adhesive) exhibits adhesiveness due to drying and is capable of bonding materials to each other.

Specific examples of a curing type adhesive which exhibits adhesiveness by being reacted include an active energy ray-curing type adhesive such as a (meth)acrylate-based adhesive, and a cationic polymerization curing type adhesive. The (meth)acrylate denotes acrylate and/or methacrylate. Examples of a curable component in the (meth)acrylate-based adhesive include a compound having a (meth)acryloyl group and a compound having a vinyl group. In addition, as the cationic polymerization curable adhesive, a compound having an epoxy group or an oxetanyl group can also be used. The compound having an epoxy group is not particularly limited as long as the compound has at least two epoxy groups in a molecule, and various generally known curable epoxy compounds can be used. Preferred examples of the epoxy compound include a compound (aromatic epoxy compound) containing at least two epoxy groups and at least one aromatic ring in a molecule and a compound (alicyclic epoxy compound) containing at least two epoxy groups in a molecule, in which at least one of the epoxy groups is formed between two adjacent carbon atoms constituting an alicyclic ring.

Among these, from the viewpoint of heat deformation resistance, an ultraviolet curable adhesive which is cured by irradiation with ultraviolet rays is preferably used.

In a case where the film according to the first embodiment of the present invention includes an adhesive layer, from the viewpoint that the maximum height difference of undulation is likely to be reduced, the film thickness of the adhesive layer is preferably 20 μm or less, more preferably 10 μm or less, still more preferably 8 μm or less, and particularly preferably 5 μm or less. The lower limit of the film thickness of the adhesive layer is not particularly limited, but is, for example, 0.1 μm or more in many cases.

In the first embodiment of the film according to the present invention, two or more adhesive layers may be included. For example, in the aspect shown in FIG. 1, the adhesive layer may be disposed between the first light-absorbing anisotropic layer 12a and the first retardation layer 14a, between the first retardation layer 14a and the second retardation layer 14b, and between the second retardation layer 14b and the second light-absorbing anisotropic layer 12b, or may be disposed between two of the three.

### (Antireflection Layer)

The film according to the first embodiment of the present invention may include an antireflective layer. The antireflective layer is preferably disposed on the outermost side of the film according to the first embodiment of the present invention.

The type of the antireflective layer is not particularly limited, and for example, a known antireflective layer such as a dielectric layer, an interference reflective layer in which a high-refractive-index material and a low-refractive-index material are alternately laminated, and a moth-eye structure in which a shape is formed on the surface can be applied.

As the antireflective layer, an antireflective layer having a moth-eye structure on the surface is preferable.

Examples of a method of providing the antireflective layer include a method of bonding an anti-reflective film to the film according to the first embodiment of the present invention through a pressure sensitive adhesive layer to provide the antireflective layer. The anti-reflective film is a film having a known antireflective layer.

The surface reflectivity of the film according to the first embodiment of the present invention is preferably 5.0% or less, more preferably 3.0% or less, still more preferably 1.0% or less, and particularly preferably 0.5% or less. The lower limit of the surface reflectivity is not particularly limited, but is 0.1% or more in many cases.

The above-described surface reflectivity can be achieved, for example, by a method of disposing the antireflective layer on one surface of the film according to the first embodiment of the present invention.

As the surface reflectivity, a value measured by the following method is adopted.

Specifically, a black PET film (trade name “Kukkuri Mieru”, manufactured by Tomogawa Co., Ltd.) is bonded to a surface opposite to the surface on which the surface reflectivity is measured, and the specular reflectivity is measured using a spectrophotometer. As the above-described spectrophotometer, a spectrophotometer in which an option ARV-474 is mounted on a V-750 (both manufactured by JASCO Corporation) is used. The measurement conditions are as follows.
Incidence angle: 5°
Receiving angle: 5°
Wavelength range: 380 to 780 nm

### (Other Layers)

The film according to the first embodiment of the present invention may have a layer (other layers) other than the above-described layers.

Examples of the other layers include a protective layer, an oxygen barrier layer, an ultraviolet absorbing layer, and a blue light absorbing layer.

### (Production Method)

A manufacturing method of the film according to the first embodiment of the present invention is not particularly limited.

Examples thereof include a method of forming a light-absorbing anisotropic layer (first light-absorbing anisotropic layer 12a), a retardation layer (first retardation layer 14a and second retardation layer 14b), and a light-absorbing anisotropic layer (second light-absorbing anisotropic layer 12b), and bonding each layer with a pressure sensitive adhesive layer or an adhesive layer.

It is preferable that the film according to the first embodiment of the present invention, which is obtained by bonding with the pressure sensitive adhesive layer as described above, is further subjected to a heat treatment. By performing the heat treatment, air bubbles or the like which may be generated during the bonding with the pressure sensitive adhesive layer can be removed, and the maximum height difference of undulation is likely to be reduced.

In addition, a pressurization treatment may be performed at the same time as the heat treatment. By performing the pressurization treatment, air bubbles or the like which may be generated during the bonding with the pressure sensitive adhesive layer are easily removed.

In addition, the above-described heat treatment may be performed in a case of performing the bonding. In addition, in a case of performing the bonding, the above-described pressurization treatment may be performed at the same time as the heat treatment.

Examples of the above-described heat treatment include an autoclave treatment, an infrared heating treatment, a heat pressing treatment, and a heat lamination treatment.

### Second Embodiment

The film according to the second embodiment of the present invention includes a light-absorbing anisotropic layer and a polarizer. An angle formed by a transmittance central axis of the light-absorbing anisotropic layer and a normal direction of the light-absorbing anisotropic layer is 0° to 45°. The maximum height difference of the undulation in a region of 10 mm×10 mm on the film surface is 1.2 μm or less.

FIG. 2 is a schematic view showing an example of the film according to the second embodiment of the present invention.

A film 10B shown in FIG. 2 includes a light-absorbing anisotropic layer 12 and a polarizer 16. In the light-absorbing anisotropic layer 12 shown in FIG. 2, an angle formed by a transmittance central axis and a normal direction of the light-absorbing anisotropic layer 12 is 0° (corresponding to a black double arrow in the light-absorbing anisotropic layer 12 in FIG. 2). In addition, in the aspect shown in FIG. 2, the polarizer 16 has an absorption axis in a direction orthogonal to a left-right direction of the paper surface (corresponding to a black double arrow in the polarizer 16 in FIG. 2).

In the film according to the second embodiment having the configuration shown in FIG. 2, light incident from a transmittance central axis direction (direction of a black arrow in FIG. 2) of the light-absorbing anisotropic layer 12 transmits through the light-absorbing anisotropic layer 12. A part of the light transmitted through the light-absorbing anisotropic layer 12 is absorbed by the polarizer 16 as a polarized light component that vibrates in a direction orthogonal to the left-right direction of the paper surface, but a part of the light is transmitted through the polarizer 16.

On the other hand, in the light incident from a direction tilted from the transmittance central axis (direction of a white arrow in FIG. 2), a component in a vibration direction in an in-plane direction of a plane including the direction and the transmittance central axis (hereinafter, also referred to as “P-polarized light” in this paragraph) is partially absorbed by the light-absorbing anisotropic layer 12, and a component in a vibration direction in a direction orthogonal to the P-polarized light (hereinafter, also referred to as “S-polarized light”) is transmitted through the light-absorbing anisotropic layer 12 with little absorption. In this case, the light incident from the direction tilted from the transmittance central axis is light having a large amount of S-polarized light component in a case of being transmitted through the light-absorbing anisotropic layer 12.

Here, in FIG. 2, a plane including the direction tilted from the transmittance central axis and the transmittance central axis is orthogonal to an absorption axis direction of the polarizer 16. In the aspect shown in FIG. 2, the S-polarized light component in the light transmitted through the light-absorbing anisotropic layer 12 is absorbed by the polarizer 16 because the absorption axis direction of the polarizer 16 and the vibration direction of the S-polarized light substantially match with each other.

As described above, in the aspect shown in FIG. 2, the light incident from the direction tilted from the transmittance central axis at a predetermined azimuthal angle is absorbed by the light-absorbing anisotropic layer 12 or the polarizer 16. On the other hand, a part of the light incident from the transmittance central axis direction is transmitted without being absorbed. Therefore, in the aspect shown in FIG. 2, in a case of being applied to AR glasses, the aspect functions as a filter in which the transmittance of light incident from the transmittance central axis direction (for example, a visual perception direction) is high and the transmittance of light incident from an oblique direction is low. Such a filter can prevent external light from being incident into a diffraction element provided in AR glasses from an oblique direction, and thus can suppress rainbow unevenness in a case of being applied to AR glasses.

In the aspect shown in FIG. 2, the S-polarized light component in the light incident from the direction tilted from the transmittance central axis in a plane parallel to the absorption axis direction of the polarizer 16 and the transmittance central axis is transmitted without being absorbed by the polarizer 16. Therefore, the orientation of the absorption axis of the polarizer 16 can be appropriately adjusted according to the direction of light to be shielded.

Hereinafter, a second embodiment of the film according to the present invention will be described in detail.

### (Maximum Height Difference of Undulation)

As described above, in the second embodiment of the film according to the present invention, the maximum height difference of undulation in a region of 10 mm×10 mm is 1.2 μm or less.

The maximum height difference of undulation of the film according to the present invention is the same as that in the first embodiment and the preferred aspect, and thus the description thereof will be omitted.

### (Optical Absorption Anisotropic Layer)

The second embodiment of the film according to the present invention includes a light-absorbing anisotropic layer. In the light-absorbing anisotropic layer, an angle between a transmittance central axis of the light-absorbing anisotropic layer and a normal direction of the light-absorbing anisotropic layer is 0° to 45°.

The light-absorbing anisotropic layer in the second embodiment of the film according to the present invention is the same as the light-absorbing anisotropic layer in the first embodiment and the preferred aspect thereof, and thus the description thereof will be omitted.

### (Polarizer)

The second embodiment of the film according to the present invention includes a polarizer.

The polarizer is preferably a linear polarizer having an absorption axis in an in-plane direction. As the linear polarizer, a known polarizer can be applied.

Examples of the linear polarizer include an absorptive polarizing plate containing an iodine compound and a reflective type polarizing plate such as a wire grid. The polarization axis is synonymous with a transmission axis.

As the absorptive polarizing plate, for example, any of an iodine-based polarizing plate, a dye-based polarizing plate using a dichroic dye, and a polyene-based polarizing plate can be used. The iodine-based polarizing plate and the dye-based polarizing plate are generally prepared by adsorbing iodine or a dichroic dye into polyvinyl alcohol and stretching the polyvinyl alcohol.

In addition, it is also possible to use a linear polarizer obtained by aligning the above-described dichroic coloring agent in an in-plane direction.

### (Adhesive Layer and Adhesive Layer)

The second embodiment of the film according to the present invention may include at least one of a pressure sensitive adhesive layer or an adhesive layer.

The adhesive layer and the adhesive layer in the second embodiment of the film according to the present invention are the same as the adhesive layer and the adhesive layer in the first embodiment, including the preferred aspects, and thus the description thereof will be omitted.

### (Retardation Layer)

The second embodiment of the film according to the present invention may include a retardation layer. In the second embodiment of the film according to the present invention, it is preferable that the retardation layer is disposed between the light-absorbing anisotropic layer and the polarizer.

As the retardation layer, for example, a B-plate is suitably exemplified.

The B-plate refers to a biaxial optical member in which the refractive indices nx, ny, and nz are values different from each other.

Re (in-plane retardation) of the B-plate is more than 80 nm and less than 250 nm, more preferably 100 nm or more and less than 250 nm, and still more preferably 100 nm or more and 200 nm or less.

In addition, an Nz coefficient of the B-plate is preferably more than 1.5, more preferably 2.0 or more and 10.0 or less, and still more preferably 3.0 or more and 5.0 or less. The Nz coefficient is a value calculated by Nz=(nx−nz)/(nx−ny).

It is preferable that Rth of the B-plate is set such that both Re and the Nz coefficient are in the above-described preferable ranges. Specifically, Rth is preferably more than 60 nm.

In addition, in a case where a direction of an absorption axis of the polarizer is set to 0°, an azimuthal angle (an angle formed with the absorption axis of the polarizer) of a slow axis of the B-plate is preferably −10° to 10°, more preferably −5° to 5°, and most preferably 0° (that is, parallel to the absorption axis of the polarizer). That is, the angle between the slow axis of the B-plate and the absorption axis of the polarizer is preferably 10° or less, more preferably 5° or less, and most preferably 0°.

In a case where the optical characteristics of the B-plate are in the above-described ranges, in a view in a direction oblique to the polarizer absorption axis in a film plane instead of a direction parallel or perpendicular thereto, deviations from the polarizer absorption axis and the vertical direction of the absorption axis can be compensated for, and the transmittance in the direction can be reduced.

In the optical filter according to the embodiment of the present invention, as the retardation layer, for example, a combination of a positive A-plate and a positive C-plate can also be suitably used. That is, as the retardation layer, a laminate where a positive A-plate and a positive C-plate are laminated can also be suitably used.

Here, the positive A-plate refers to an optical member in which refractive indices nx, ny, and nz satisfy the following Expression (1).

$$nx > ny {}_{}^{\cdot } {=}_{\cdot }^{} nz \qquad Expression ( 1 )$$

In addition, the positive C-plate refers to an optical member in which the refractive indices nx, ny, and nz satisfy the following expression (2).

Re of the laminate including the positive C-plate and the positive A-plate is preferably more than 80 nm and less than 250 nm, more preferably 100 to 200 nm, and still more preferably 100 to 150 nm. Since the positive C-plate satisfies Re≈0, Re of the laminate including the positive C-plate and the positive A-plate is substantially the same as Re of the positive A-plate, and the slow axis of the laminate including the positive C-plate and the positive A-plate is substantially the same as the slow axis of the positive A-plate.

In addition, the azimuthal angle of the slow axis of the positive A-plate is preferably 80° to 100°, more preferably 85° to 95°, and still more preferably 90° (that is, perpendicular to the polarizer absorption axis). That is, an angle between the slow axis of the positive A-plate and the absorption axis of the polarizer is preferably 80° to 100°, more preferably 85° to 95°, and still more preferably 90°.

Rth of the laminate between the positive C-plate and the positive A-plate is preferably less than −60 nm, more preferably −600 to −100 nm, and still more preferably −500 nm to −200 nm. Since the positive A plate satisfies Rth≈Re/2, Rth of the laminate including the positive C-plate and the positive A-plate is the sum of Rth of the positive A-plate and Rth of the positive C-plate.

In a case where the optical characteristics of the positive C-plate and the positive A-plate are in the above-described ranges, in a view in a direction oblique to the polarizer absorption axis in a film plane instead of a direction parallel or perpendicular thereto, deviations from the polarizer absorption axis and the vertical direction of the polarizer absorption axis can be compensated for, and the transmittance in the direction can be reduced.

In addition, it is also preferable that the wavelength dispersion of R^{e} and Rth of the positive C-plate and the positive A-plate is reverse dispersion.

More specifically, it is preferable that the wavelength dependence of the retardation layer satisfies Re(450 nm)<Re(550 nm)<Re(650 nm) or Rth(450 nm)<Rth(550 nm)<Rth(650 nm).

### (Alignment Film)

The film according to the second embodiment of the present invention may include an alignment film. The aspect of the alignment film in the second embodiment of the film according to the present invention is the same as the aspect and the preferred aspect in the first embodiment, and thus the description thereof will be omitted.

### (Antireflection Layer)

The film according to the second embodiment of the present invention may include an antireflective layer. The aspect of the antireflective layer in the second embodiment of the film according to the present invention is the same as the aspect and the preferred aspect in the first embodiment, and thus the description thereof will be omitted.

In addition, the surface reflectivity in the second embodiment of the film according to the present invention is the same as that in the first embodiment including the preferred aspect, and thus the description thereof will be omitted.

In addition, the film according to the second embodiment of the present invention may include other layers described in the first embodiment of the film according to the present invention.

### <Optical Member>

The optical member according to the embodiment of the present invention includes the above-described film according to the embodiment of the present invention (the first embodiment and the second embodiment) and a transparent support.

Hereinafter, the transparent support and the configuration which the optical member according to the embodiment of the present invention may include will be described.

### [Transparent Support]

The optical member according to the embodiment of the present invention includes a transparent support.

In the aspect shown in FIG. 3 described later, an aspect in which the transparent support included in the optical member is a cover glass is shown, but the transparent support is not particularly limited as long as it can support the above-described film according to the embodiment of the present invention, and a known transparent support can be applied. The transparent support is intended to refer to a support having a visible light transmittance of 60% or more, which preferably has a visible light transmittance of 80% or more, and more preferably 90% or more.

The material constituting the transparent support may be an organic substance such as a polymer or an inorganic substance such as glass.

Examples of the polymer constituting the transparent support include cellulose-based polymers; acrylic polymers having an acrylic acid ester polymer such as polymethyl methacrylate and a lactone ring-containing polymer; thermoplastic norbornene-based polymers; polycarbonate-based polymers; polyester-based polymers such as polyethylene terephthalate and polyethylene naphthalate; styrene-based polymers such as polystyrene and an acrylonitrile-styrene copolymer; polyolefin-based polymers such as polyethylene, polypropylene, and an ethylene-propylene copolymer; vinyl chloride-based polymers; amide-based polymers such as nylon and aromatic polyamide; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; polymers obtained by mixing these polymers; and the like.

As the glass constituting the transparent support, a known glass in the related art can be used.

From the viewpoint of further suppressing the generation of multiple images in a case where the optical member is applied to AR glasses, the maximum height difference of undulation on the side of the transparent support on which the film is disposed is preferably 0.8 μm or less and more preferably 0.6 μm or less. The lower limit of the maximum height difference of undulation on the side of the transparent support on which the film is disposed is not particularly limited, but is 0.01 μm or more in many cases. The maximum height difference of undulation of the transparent support is obtained by the same method as the method of measuring the average value Wg of the maximum height difference of undulation in the above-described film.

The transparent support may have a protective layer on a surface on a side opposite to a side on which the film according to the embodiment of the present invention is provided. The protective layer preferably has a high surface hardness and has a function of preventing the surface of the transparent support from being scratched in a case where another object comes into contact with the transparent support.

The shape of the transparent support is not particularly limited. The shape may be a long shape or may be a shape corresponding to a head-mounted display. In addition, the transparent support may have a planar shape or may have a curved surface.

In a case where the transparent support does not have a planar shape, the entire shape of the transparent support can be removed during the analysis of the maximum height difference of undulation, and the maximum height difference of undulation can be calculated.

### [Pressure Sensitive Adhesive Layer and Adhesive Layer]

The optical member according to the embodiment of the present invention may include a pressure sensitive adhesive layer or an adhesive layer between the transparent support and the film according to the embodiment of the present invention.

Since the pressure sensitive adhesive layer and the adhesive layer which may be included in the optical member are the same as the pressure sensitive adhesive layer and the adhesive layer of the film according to the embodiment of the present invention (the first embodiment and the second embodiment), the description thereof will be omitted.

In a case where the film according to the embodiment of the present invention (the first embodiment and the second embodiment) includes an antireflection layer, the antireflection layer is preferably provided on a side opposite to the transparent support side.

### <Optical Device and Head-Mounted Display>

The optical device according to the embodiment of the present invention includes the optical member according to the embodiment of the present invention and a light guide plate in which a diffraction element is disposed on a surface, in which the optical member is disposed to be spaced from the light guide plate.

In addition, the head-mounted display according to the embodiment of the present invention includes the optical device according to the embodiment of the present invention and an image display element.

Hereinafter, the head-mounted display according to the embodiment of the present invention including the optical device according to the embodiment of the present invention will be described with reference to the drawing.

FIG. 3 is a schematic cross-sectional view showing a part of AR glasses (the head-mounted display according to the embodiment of the present invention).

Specifically, AR glasses 40 shown in FIG. 3 include an optical device 30 and an image display element 42 that causes video light L1 to be incident into the optical device.

The optical device 30C includes a light guide plate 32, and an incidence diffraction element 34 and an emission diffraction element 36 that are disposed on a side of the light guide plate 32 opposite to the image display element 42. In addition, the optical device 30 includes an optical member 20 consisting of a cover glass 22 and a film 10. In the optical member 20, the film 10 is disposed on the light guide plate 32 side. The film 10 and the incidence diffraction element 34 and the emission diffraction element 36 are disposed to be spaced from each other.

The optical device 30 shown in FIG. 3 is the optical device according to the embodiment of the present invention including the film according to the embodiment of the present invention.

A disposition position of the incidence diffraction element 34 corresponds to an incidence position of the video light L1 from the image display element 42. The disposition position of the emission diffraction element 36 corresponds to an emission position of the video light L1 from the light guide plate 32, that is, an observation position of the video light L1 by the user.

The incidence diffraction element 34 diffracts the video light L1 incident on the light guide plate 32 from the image display element 42 into the light guide plate 32. The diffracted video light L1 travels in an in-plane direction of the light guide plate 32 while being totally reflected in the light guide plate 32. The emission diffraction element 36 diffracts the light transmitted in the light guide plate 32 to a user side.

In the emission diffraction element 36 of the AR glasses 40, as described above, a part of the video light L1 may be emitted to a side opposite to the user side (optical member 20 side) to generate stray light Ls. Even in a case where such stray light Ls is generated, it is considered that the maximum height difference of undulation of the film 10 (film according to the embodiment of the present invention) is equal to or less than a predetermined value. Therefore, the stray light Ls is reflected in a direction parallel to the video light L1, and thus multiple images are less likely to be generated.

The light guide plate 32 included in the optical device 30 is not particularly limited, and a well-known light guide plate in the related art used in an image display device or the like, such as a light guide plate used in various AR glasses or a light guide plate used in a backlight unit of a liquid crystal display device, can be used.

The incidence diffraction element 34 and the emission diffraction element 36 included in the optical device 30 are transmissive diffraction elements, and a rear surface landscape can be simultaneously visually recognized through the incidence diffraction element 34 and the emission diffraction element 36. The transmissive diffraction element is not particularly limited, and for example, a well-known diffraction element used in AR glasses or the like, such as a relief type diffraction element, a diffraction element using liquid crystal, or a volume hologram diffraction element, can be used.

At least one of the incidence diffraction element 34 or the emission diffraction element 36 may be a reflective diffraction element.

The image display element 42 included in the head-mounted display according to the embodiment of the present invention is not particularly limited, and various well-known image display elements (displays) used in various image display devices such as AR glasses can be used.

Examples of the image display element 42 include a liquid crystal display, an organic electroluminescent display, a digital light processing (DLP) display, a micro-electro-mechanical systems (MEMS) type display, and a micro light emitting diode (LED) display. The liquid crystal display includes a liquid crystal on silicon (LCOS) or the like.

The image display element 42 may display a monochrome image, a two-color image, or a color image.

In the AR glasses 40 according to the aspect shown in FIG. 3, an intermediate diffraction element may be provided in addition to the incidence diffraction element 34 and the emission diffraction element 36. The intermediate diffraction element has a function of bending a traveling direction of the video light L1 introduced into the light guide plate by the incidence diffraction element in a direction in which the emission diffraction element 36 is disposed. As the intermediate diffraction element, the same diffraction element as the incidence diffraction element 34 and the emission diffraction element 36 can be applied.

In addition, in the AR glasses 40 according to the aspect shown in FIG. 3, in the optical member 20 included in the optical device 30, the film 10 is disposed on the light guide plate 32 side, but in the optical member 20 included in the optical device 30, the film 10 may be disposed on a side opposite to the light guide plate 32 side. That is, the cover glass 22 (transparent support) in the optical member 20 may be disposed on the light guide plate 32 side.

By adopting the above-described configuration, the stray light Ls is less likely to be reflected by the film 10, and the generation of multiple images can be further suppressed.

In addition, since the film (film 10) according to the embodiment of the present invention can suppress rainbow unevenness, the rainbow unevenness is suppressed in the head-mounted display (AR glasses 40) according to the embodiment of the present invention including the film according to the embodiment of the present invention.

In the optical device 30, it is preferable that the optical member 20 is disposed to overlap with a region corresponding to a portion where at least the incidence diffraction element 34 and the emission diffraction element 36 are disposed on the light guide plate 32.

By disposing the optical member 20 to overlap with the above-described region, external light from an oblique direction is less likely to be incident on the incidence diffraction element 34 and the emission diffraction element 36, and the occurrence of rainbow unevenness can be further suppressed.

### EXAMPLES

Hereinafter, the present invention will be described in more detail based on Examples.

The materials, the amounts of materials used, the proportions, the treatment details, the treatment procedure, and the like shown in Examples below may be modified as appropriate as long as the modifications do not depart from the spirit of the present invention. Therefore, the scope of the present invention should not be construed as being limited to Examples shown below.

### Example 1

A film 1 was obtained by the following procedure, and a head-mounted display (AR glasses) A1 used in Example 1 was produced.

### [Preparation of Light-Absorbing Anisotropic Layer]

A light-absorbing anisotropic layer was produced by the following procedure.

### (Formation of Alignment Film)

A surface of a cellulose acylate film (TAC substrate; manufactured by FUJIFILM Corporation, TG40) with a thickness of 40 μm was saponified with an alkaline solution, and the following composition 1 for forming an alignment film was applied thereto using a wire bar.

The support on which the coating film was formed was dried with hot air at 60° C. for 60 seconds and further dried with hot air at 100° C. for 120 seconds to form an alignment film AL1, thereby obtaining a cellulose acylate film 1 with an alignment film. A film thickness of the alignment film AL1 was 1 μm.

Composition 1 for forming alignment film

| | |
|---|---|
| Modified polyvinyl alcohol PVA-1 shown below | 3.80 parts by mass |
| IRGACURE 2959 | 0.20 parts by mass |
| Water | 70 parts by mass |
| Methanol | 30 parts by mass |

Modified Polyvinyl Alcohol PVA-1 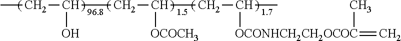
(Formation of light-absorbing anisotropic layer V1)

The obtained cellulose acylate film 1 with an alignment film was continuously coated with the following composition P¹ for forming a light-absorbing anisotropic layer using a wire bar, heated at 120° C. for 60 seconds, and cooled to room temperature (23° C.).

Next, the coating layer was heated at 85° C. for 60 seconds, and then cooled to room temperature again.

Thereafter, the coating layer was irradiated from a normal direction to the film with light for 2 seconds under an irradiation condition of illuminance of 200 mW/cm² using a LED lamp (central wavelength: 365 nm) to produce a light-absorbing anisotropic layer V1 on the alignment film AL1. A film thickness of the light-absorbing anisotropic layer V1 was 2.7 μm.

Composition P1 for forming light-absorbing anisotropic layer

| | |
|---|---|
| Dichroic substance D-1 shown below | 0.69 parts by mass |
| Dichroic substance D-2 shown below | 0.17 parts by mass |
| Dichroic substance D-3 shown below | 1.13 parts by mass |
| Polymer liquid crystal compound P-1 shown below | 8.67 parts by mass |
| Liquid crystal compound L-1 shown below | 1.97 parts by mass |
| IRGACURE OXE-02 (manufactured by BASF SE) | 0.20 parts by mass |
| Alignment agent E-1 shown below | 0.16 parts by mass |
| Alignment agent E-2 shown below | 0.16 parts by mass |
| Surfactant F-1 shown below | 0.012 parts by mass |
| Cyclopentanone | 78.17 parts by mass |
| Benzyl alcohol | 8.69 parts by mass |

Dichroic substance D-1 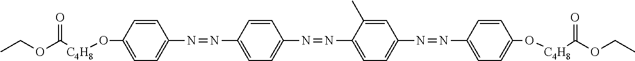
Dichroic substance D-2 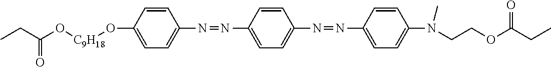
Dichroic substance D-3 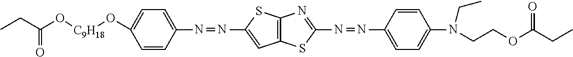
High-molecular-weight liquid crystal compound P-1 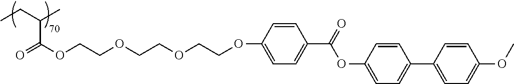 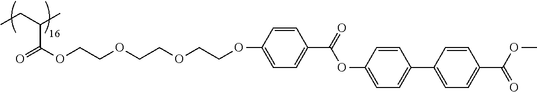 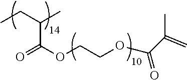
Liquid crystal compound L-1 [mixture of 84:14:2 (mass ratio) of the following liquid crystal compounds (RA), (RB), and (RC)] 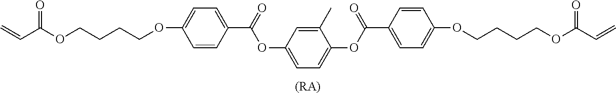 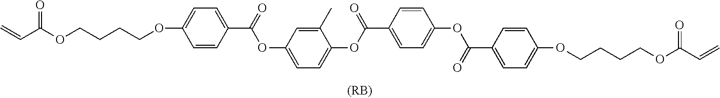 [SMILES: C=CC(=O)OCCCCOc1ccc(C(=O)Oc2ccc(C(=O)Oc3ccc(OC(=O)c4ccc(OCCCCOC(=O)C=C)cc4)cc3C)cc2)cc1] 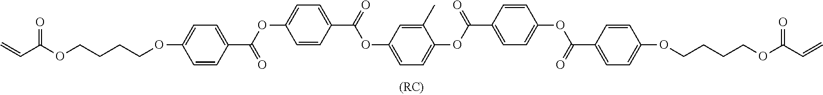 [SMILES: C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]
Alignment agent E-1 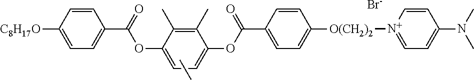
Alignment agent E-2 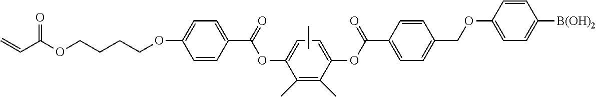
Surfactant F-1 (in the following formulae, TMS represents a trimethylsilyl group)

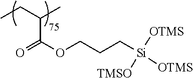

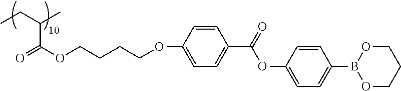

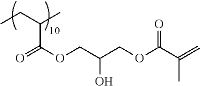

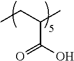

### (Formation of Protective Layer H1)

A coating film was formed by continuously coating the obtained light-absorbing anisotropic layer V1 with the following composition B1 for forming a protective layer using a wire bar.

Next, the support on which the coating film was formed was dried with hot air at 60° C. for 60 seconds and further dried with hot air at 100° C. for 120 seconds to form a protective layer H1, thereby producing an optical film Vf having the light-absorbing anisotropic layer V1. A film thickness of the protective layer was 0.5 μm. In addition, as a result of measuring the angle formed by the transmittance central axis of the light-absorbing anisotropic layer V1 and the normal direction of the light-absorbing anisotropic layer V1 in the above-described procedure, the angle was 0°.

Composition B1 for forming protective layer

| | |
|---|---|
| Modified polyvinyl alcohol PVA-1 shown below | 3.80 parts by mass |
| IRGACURE 2959 | 0.20 parts by mass |
| Coloring agent compound G-1 shown below | 0.08 parts by mass |
| Water | 70 parts by mass |
| Methanol | 30 parts by mass |

Modified Polyvinyl Alcohol PVA-1 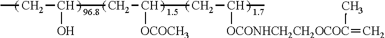
Coloring agent compound G-1

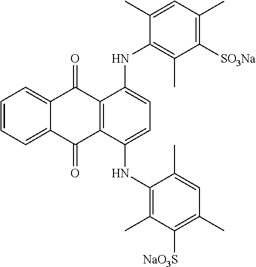

### (Preparation of Retardation Layer)

A retardation layer was produced by the following procedure.

### (Formation of Alignment Film 2)

One surface of a cellulose acylate film (TAC base material; manufactured by FUJIFILM Corporation, TG40) having a thickness of 40 μm was continuously coated with the following composition 2 for forming an alignment film using a #14 wire bar. After the application, the liquid was dried by hot air at 60° C. for 60 seconds, and further dried by hot air at 100° C. for 120 seconds.

Composition of composition 2 for forming alignment film

Modified polyvinyl alcohol PVA-1 shown above 10 parts by mass

| | | |
|---|---|---|
| Water | 308 | parts by mass |
| Methanol | 70 | parts by mass |
| Isopropanol | 29 | parts by mass |
| Photopolymerization initiator | 0.8 | parts by mass |
| (IRGACURE 2959, manufactured by BASF SE) | | |

### (Formation of λ/2 Layer)

The alignment film 2 produced above was continuously subjected to a rubbing treatment. In this case, the longitudinal direction of the elongated film was parallel to the transport direction, and the angle formed between the longitudinal direction of the film and the rotation axis of the rubbing roller was 90° (in a case where the width direction of the film was defined as 0°, the longitudinal direction of the film was defined as 90°, and the counterclockwise direction was expressed as a positive value with reference to the width direction of the film observed from the alignment film side, the rotation axis of the rubbing roller was) 0°.

The alignment film 2 produced above was continuously coated with a retardation layer coating liquid containing a discotic liquid crystal compound having the following formulation using a #5.0 wire bar to produce a λ/2 layer. The transportation speed (V) of the film was 26 m/min. The coating liquid was heated with hot air at 130° C. for 90 seconds and then with hot air at 100° C. for 60 seconds for drying of the solvent of the coating liquid and alignment aging of the discotic liquid crystal compound, and irradiated with UV light at 80° C. to immobilize the alignment of the liquid crystal compound, thereby obtaining an optical film Rf having a λ/2 layer. The thickness of the λ/2 layer was 2.2 μm, and Re at 550 nm was 270 nm. It was found that the average tilt angle with respect to the film surface of the disk plane of the discotic liquid crystal compound was 90°, and the discotic liquid crystal compound was vertically aligned with respect to the film surface. In addition, the angle of the slow axis of the λ/2 layer was parallel to the rotation axis of the rubbing roller, and in a case where the width direction of the film was 0° (the longitudinal direction was) 90°, the slow axis was 0° as viewed from the λ/2 layer side.

Formulation of retardation layer coating liquid

| | |
|---|---|
| Discotic liquid crystal-1 shown below | 80 parts by mass |
| Discotic liquid crystal-2 shown below | 20 parts by mass |
| Alignment film interface alignment agent-3 shown below | 0.55 parts by mass |
| Alignment film interface alignment agent-4 shown below | 0.05 parts by mass |
| Surfactant F-2 shown below | 0.09 parts by mass |
| Modified trimethylolpropane triacrylate | 10 parts by mass |
| Photopolymerization initiator | 3.0 parts by mass |
| (IRGACURE 907, manufactured by BASF SE) | |
| Methyl ethyl ketone | 200 parts by mass |

Discotic Liquid Crystal-1 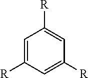 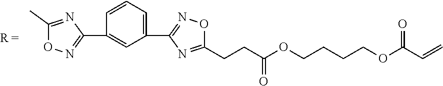 [SMILES: C=CC(=O)OCCCCOC(=O)CCc1nc(-c2cccc(-c3noc(C)n3)c2)no1]
Discotic Liquid Crystal-2 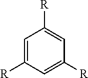 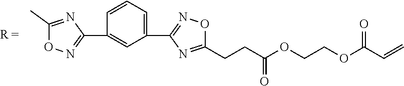 [SMILES: C=CC(=O)OCCOC(=O)CCc1nc(-c2cccc(-c3noc(C)n3)c2)no1]
Alignment Film Interface Alignment Agent-3 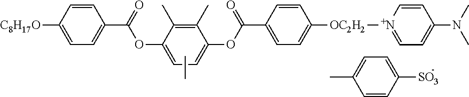
Alignment Film Interface Alignment Agent-4 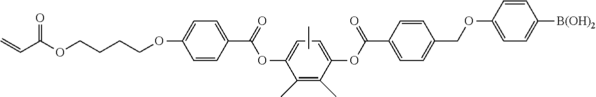
Surfactant F-2

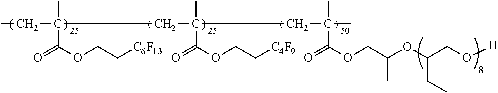

### [Production of Film 1]

A surface of the optical film Vf having the light-absorbing anisotropic layer V1, on which the protective layer H1 was formed, and a surface of the optical film Rf having the λ/2 plate, on the cellulose acylate film side, were bonded to each other using a pressure sensitive adhesive layer (OPTERIA (registered trademark) NCF-D692 (film thickness: 15 μm, manufactured by Lintec Corporation).

Furthermore, an optical film Rf having a λ/2 layer, which was different from the bonded optical film Rf, was prepared, and a surface on the λ/2 layer side and a surface on the λ/2 layer side bonded in the above-described procedure were bonded to each other using the above-described pressure sensitive adhesive layer. In a case of bonding the λ/2 layers, the λ/2 layers were bonded such that an angle between an in-plane slow axis of one λ/2 layer and an in-plane slow axis of the other λ/2 layer was 45°.

Next, an optical film Vf having a light-absorbing anisotropic layer V1, which was different from the bonded optical film Vf, was prepared, and a surface of the optical film Vf on which the protective layer H1 was formed and a surface of the optical film Rf, which was already bonded, on the cellulose acylate film side were bonded to each other using the above-described pressure sensitive adhesive layer. After the bonding, the bonded optical film was further treated for 30 minutes under conditions of 50° C. and 5 atm using an autoclave (Model: PTU507H, manufactured by HIRAYAMA MFG. CORP.) to obtain a film 1. The film 1 had the optical film Vf, the optical film Rf, the optical film Rf, and the optical film Vf in this order, and the optical films were bonded to each other using the above-described pressure sensitive adhesive layer (see the table below).

### [Measurement of Maximum Height Difference of Undulation]

In the above-described procedure, the maximum height difference of undulation of the produced film 1 was measured.

An average value (Wg) of the maximum height differences of undulation of the glass to which the film 1 was bonded was 0.4 μm.

The measurement results are shown in the table below.

### [Measurement of Surface Reflectivity]

In the above-described procedure, the surface reflectivity of the produced film 1 was measured.

The surface reflectivity of the above-described cellulose acylate film was 4.0%.

### [Production of Optical Member O1]

The above-described film 1 and glass (manufactured by Corning Incorporated, EAGLE XG) were bonded to each other with the same pressure sensitive adhesive layer as described above to obtain an optical member O1.

### [Production of Head-Mounted Display A1]

A cover glass (right eye side) on a side where a light guide plate of VUZIX BLADE 2 SMART GLASSES (manufactured by Vuzix Corporation) was disposed was removed. Subsequently, the optical member O1 was disposed at a position where the cover glass was removed such that the film 1 side of the optical member O1 was on the light guide plate side, thereby obtaining a head-mounted display A1.

### Example 2

A film 2 was obtained by the following procedure, and a head-mounted display A2 was produced.

### [Production of Polarizing Plate]

A polarizing plate in which a thickness of a polarizer was 8 μm and one surface of the polarizer was exposed was obtained by the same method as in the polarizing plate O2 with a single-sided protective film described in WO2015/166991A.

### [Production of Film 2]

A surface of the polarizing plate on the polarizer side and a surface of the optical film Vf having the light-absorbing anisotropic layer V1 on which the protective layer H1 was formed were bonded to each other with the pressure sensitive adhesive layer to obtain a film 2. The film 1 was treated with an autoclave by the same procedure as in a case of obtaining the film 1.

### [Production of Head-Mounted Display A2]

An optical member O2 was obtained in the same manner as in Example 1, except that the film 1 used in the production of the optical member O1 of Example 1 was changed to the film 2, and a head-mounted display A2 was obtained.

### Example 3

A film 3 was obtained by the following procedure to produce a head-mounted display A3.

### [Manufacture of Antireflection Film]

An antireflection film having an antireflection layer with a three-layer structure on the surface was produced with a cellulose acylate film (TAC base material; manufactured by FUJIFILM Corporation, TG40) having a thickness of 40 μm as a base material, with reference to Example 1 of an antireflection film NO. 1 in JP2008-262187A. In a case where the surface reflectivity of the produced antireflection film on the surface opposite to the base material was measured by the above-described method, the surface reflectivity was 0.4%.

### [Production of Film 3]

One surface of the film 1 obtained in Example 1 and the surface of the antireflection film on the base material side were bonded to each other using the pressure sensitive adhesive layer to obtain a film 3. The film 1 was treated with an autoclave by the same procedure as in a case of obtaining the film 1.

### [Production of Head-Mounted Display A3]

An optical member O3 was obtained in the same manner as in Example 1, except that the film 1 used in the production of the optical member O1 of Example 1 was changed to the film 3, and a head-mounted display A2 was obtained. In a case of producing the optical member O3, one surface of the glass and the surface of the film 3 opposite to the antireflection film side were bonded to each other.

### Example 4

A film 4 was obtained by the following procedure, and a head-mounted display A4 was produced.

### [Production of Film 4]

A film 4 was obtained in the same manner as in the film 1, except that the film thickness of the pressure sensitive adhesive layer (film thickness: 15 μm) used in the production of the film 1 was changed to 5 μm.

### [Production of Head-Mounted Display A4]

An optical member O4 was obtained in the same manner as in Example 1, except that the film 1 used in the production of the optical member O1 of Example 1 was changed to the film 4, and the thickness of the pressure sensitive adhesive layer used for bonding to the glass was changed to 5 μm, and a head-mounted display A4 was obtained.

### Example 5

A head-mounted display A5 was produced by the following procedure.

### [Production of Head-Mounted Display A5]

A head-mounted display A5 was obtained in the same manner as in the head-mounted display A1, except that in the production of the head-mounted display A1 obtained in Example 1, the optical member O1 was disposed such that the glass side of the optical member O1 was on the light guide plate side.

### Example 6

A film 6 was obtained by the following procedure, and a head-mounted display A6 was produced.

### [Production of Retardation Layer B]

A retardation layer B was produced by the following procedure.

### (Extrusion Molding)

A cycloolefin resin (ARTON G7810 (manufactured by JSR Corporation)) was dried at 100° C. for 2 hours or longer, and melt-extruded at 280° C. using a biaxial kneading extruder to obtain an unstretched film. A screen filter, a gear pump, and a leaf disk filter were disposed in this order between the extruder and the die, and these were connected by a melt pipe.

The melt extrusion was performed by extruding from a T-die having a width of 1,000 mm and a lip gap of 1 mm, and casting was performed on three consecutive cast rolls set at 180° C., 175° C., and 170° C. to obtain an unstretched film.

### (Stretching/Thermal Fixation)

The above-described unstretched film being transported was subjected to a stretching step by the following method.

The unstretched film was stretched in the machine direction under the following conditions while being transported using an inter-roll machine-direction stretching machine having an aspect ratio (L/W) of 0.2.

### —Conditions—

Preheating temperature: 175° C.
Stretching temperature: 175° C.
Stretching ratio: 90%

In the obtained stretched film, Re at 550 nm was 270 nm, Rth was 140 nm, and the film thickness was 35 μm. The stretched film obtained by the above-described procedure was used as a retardation layer B. In the table later, the retardation layer B is described as “N/2 layer B”.

### [Production of Pressure-Sensitive Adhesive Layer D]

An acrylate-based polymer was prepared by the following procedure to produce a pressure-sensitive adhesive layer D.

43 parts by mass of butyl acrylate, 55 parts by mass of benzyl acrylate, 3 parts by mass of acrylic acid, and 0.3 parts by mass of 2,2′-azobisisobutyronitrile were added to a reaction container equipped with a cooling pipe, a nitrogen introduction pipe, a thermometer, and a stirring device, together with ethyl acetate, to prepare a reaction solution having a concentration of solid contents of 30% by mass. The reaction solution was reacted at 60° C. for 4 hours in a nitrogen gas stream to obtain an acrylate-based polymer solution. The average refractive index of the obtained acrylate-based polymer was measured using an Abbe refractometer (manufactured by Atago Co., Ltd.) in an environment of 23.5° C. to 26.5° C., and the refractive index was 1.52.

Next, a pressure-sensitive adhesive layer D was produced using the obtained acrylate-based polymer according to the following procedure. 2 parts by mass of trimethylolpropane triisocyanate (manufactured by Nippon Polyurethane Industry Co., Ltd., CORONATE L) and 0.1 parts by mass of 3-glycidoxypropyltrimethoxysilane were added to 100 parts by mass of the acrylate-based polymer solid contents to obtain a coating liquid for forming a pressure-sensitive adhesive layer. The coating liquid for forming a pressure-sensitive adhesive layer was applied to a separate film subjected to a surface treatment with a silicone-based release agent using a die coater, and dried at 150° C. for 3 hours to obtain a pressure-sensitive adhesive layer D.

A film thickness of the pressure-sensitive adhesive layer D was 15 μm.

### [Production of Film 6]

A film 6 was obtained in the same manner as the film 3, except that the pressure-sensitive adhesive layer (film thickness: 15 μm) used in the production of the film 3 was changed to the pressure-sensitive adhesive layer D, and the retardation layer was changed to the retardation layer B.

### [Production of Head-Mounted Display A6]

An optical member O6 was obtained in the same manner as in Example 1, except that the film 1 used in the production of the optical member O1 of Example 1 was changed to the above-described film 6, and the pressure-sensitive adhesive layer used for bonding to the glass was changed to the pressure-sensitive adhesive D layer, and a head-mounted display A6 was obtained.

### Comparative Example 1

A film C1 was obtained by the following procedure, and a head-mounted display B¹ of Comparative Example 1 was produced.

### [Production of Film C1]

A film C1 was obtained in the same manner as the film 1, except that the pressure-sensitive adhesive layer (film thickness: 15 μm) used in the production of the film 1 was changed to a pressure-sensitive adhesive layer C (SK2057 (film thickness: 25 μm, manufactured by Soken Chemical & Engineering Co., Ltd.)). In a case of obtaining the film C1, the above-described autoclave treatment was not performed.

[Production of head-mounted display B1]

An optical member OC1 was obtained in the same manner as in Example 1, except that the film 1 used in the production of the optical member O1 of Example 1 was changed to the above-described film C1, and the pressure-sensitive adhesive layer used for bonding to the glass was changed to the above-described pressure-sensitive adhesive layer C, and a head-mounted display B1 was obtained.

Regarding the films obtained in each of Examples and Comparative Examples, the maximum height difference of undulation and the surface reflectivity were measured in the same manner as in Example 1.

### <Evaluation of Multiple Images>

The head-mounted display of each of Examples and Comparative Examples was evaluated for multiple images.

Specifically, an image was displayed on the head-mounted display, and the appearance of the image was evaluated based on the following standard. The evaluation results are shown in the table below. In practice, the evaluation is preferably A evaluation, B evaluation, or C evaluation, more preferably A evaluation or B evaluation, and still more preferably A evaluation.
A: The display image was not seen as multiple images, and the image could be clearly recognized.
B: The image was slightly overlapped at a position slightly deviated from the main image, and it was slightly noticeable.
C: The image was slightly overlapped at a position slightly deviated from the main image, and it was slightly noticeable.
D: The image was seen to be overlapped at a position deviated from the main image, and it was noticeable.

### Results

The configuration, the measurement results, and the evaluation of the head-mounted display of each of Examples and Comparative Examples are shown in the table.

For each configuration, the display of the base material such as the alignment film, the protective layer, and the cellulose acylate film is omitted.

From the results shown in Table 1, it was confirmed that, in a case where a film in which the maximum height difference of undulation in a region of 10 mm×10 mm on the film surface was 1.2 μm or less was applied to AR glasses, the generation of multiple images was suppressed (Examples 1 to 6).

On the other hand, from the results shown in Table 1, in a case where the maximum height difference of undulation was more than 1.2 μm, the generation of multiple images could not be suppressed in a case where the film was applied to AR glasses (Comparative Example 1).

From the comparison between Example 1 and Example 3, it was confirmed that, in a case where the antireflection layer disposed on the outermost side of the film was further included, multiple images were less likely to occur.

From the comparison between Example 1 and Example 4, it was confirmed that, in a case where one or more layers selected from the group consisting of a pressure sensitive adhesive layer having a film thickness of 10 μm or less and an adhesive layer having a film thickness of 10 μm or less were further included, multiple images were less likely to occur.

From the comparison between Example 1 and Example 5, it was confirmed that, in a case where the transparent support (glass) in the optical member was disposed on the light guide plate side with respect to the film, multiple images were less likely to occur.

### EXPLANATION OF REFERENCES

10, 10A, 10B, 10C: film
12: light-absorbing anisotropic layer
12a: first light-absorbing anisotropic layer
12b: second light-absorbing anisotropic layer
14a: first retardation layer
14b: second retardation layer
16: polarizer
20, 20C: optical member
22: cover glass (transparent support)
30, 30C: optical device
32: light guide plate
34: incidence diffraction element
36: emission diffraction element
40, 40C: AR glasses (head-mounted display)

What is claimed is:

1. A film comprising:
at least one light-absorbing anisotropic layer,
wherein an angle between a transmittance central axis of the light-absorbing anisotropic layer and a normal direction of the light-absorbing anisotropic layer is 0° to 45°, and
a maximum height difference of undulation in a region of 10 mm×10 mm on a film surface is 1.2 μm or less.

2. The film according to claim 1, further comprising:
two light-absorbing anisotropic layers, wherein at least one or more retardation layers are provided between the two light-absorbing anisotropic layers.

3. The film according to claim 2,
wherein two retardation layers are provided, and each of the two retardation layers is a λ/2 plate.

4. The film according to claim 1, further comprising:
a polarizer.

5. The film according to any one of claim 1, further comprising:
an antireflection layer disposed on an outermost side of the film.

6. The film according to any one of claim 2, further comprising:
an antireflection layer disposed on an outermost side of the film.

7. The film according to any one of claim 3, further comprising:
an antireflection layer disposed on an outermost side of the film.

8. The film according to any one of claim 4, further comprising:
an antireflection layer disposed on an outermost side of the film.

9. The film according to any one of claim 1,
wherein a surface reflectivity is 1% or less.

10. The film according to any one of claim 1, further comprising:
one or more layers selected from the group consisting of a pressure sensitive adhesive layer having a film thickness of 10 μm or less and an adhesive layer having a film thickness of 10 μm or less.

11. The film according to any one of claim 2, further comprising:
one or more layers selected from the group consisting of a pressure sensitive adhesive layer having a film thickness of 10 μm or less and an adhesive layer having a film thickness of 10 μm or less.

12. The film according to any one of claim 3, further comprising:
one or more layers selected from the group consisting of a pressure sensitive adhesive layer having a film thickness of 10 μm or less and an adhesive layer having a film thickness of 10 μm or less.

13. The film according to any one of claim 4, further comprising:
one or more layers selected from the group consisting of a pressure sensitive adhesive layer having a film thickness of 10 μm or less and an adhesive layer having a film thickness of 10 μm or less.

14. An optical member comprising:
the film according to any one of claim 1; and
a transparent support.

15. An optical member comprising:
the film according to any one of claim 2; and
a transparent support.

16. The optical member according to claim 14,
wherein the transparent support is glass.

17. An optical device comprising: the optical member according to claim 14; and a light guide plate in which a diffraction element is disposed on a surface, wherein the optical member and the light guide plate are disposed to be spaced from each other.

18. The optical device according to claim 17, wherein the transparent support in the optical member is disposed on a light guide plate side with respect to the film.

19. A head-mounted display comprising: the optical device according to claim 17; and an image display element.

20. A head-mounted display comprising: the optical device according to claim 18; and an image display element.
